(19) United States
(12) Patent Application Publication
(10) Pub. No.: US 2014/0019447 A1
(43) Pub. Date: Jan. 16, 2014

(54) Multi-attribute search system and method for ranking objects according to their attractiveness

(71) Applicants: Yuly Goryavskiy, Antibes (FR); Svetlana Goryavskiy, Antibes (FR)

(72) Inventors: Yuly Goryavskiy, Antibes (FR); Svetlana Goryavskiy, Antibes (FR)

(21) Appl. No.: 13/719,220

(22) Filed: Dec. 18, 2012

Related U.S. Application Data
(60) Provisional application No. 61/577,030, filed on Dec. 18, 2011.

(51) Int. Cl. G06F 17/30

(52) U.S. Cl. CPC G06F 17/30867
USPC 707/732; 707/722

(57) ABSTRACT

This patent application describes a system for searching objects based on the multi-attributive (multifactorial) search criteria and method for ranking search results or arbitrary sets of objects according to their attractiveness to the user or according to their attractiveness described formally. Unlike other systems for information retrieval, our system not only sorts the objects by the usual criteria within the search query, but also numerically evaluates the attractiveness of search results using the original method of inverse query matching and other techniques that simulate the human decision-making process.

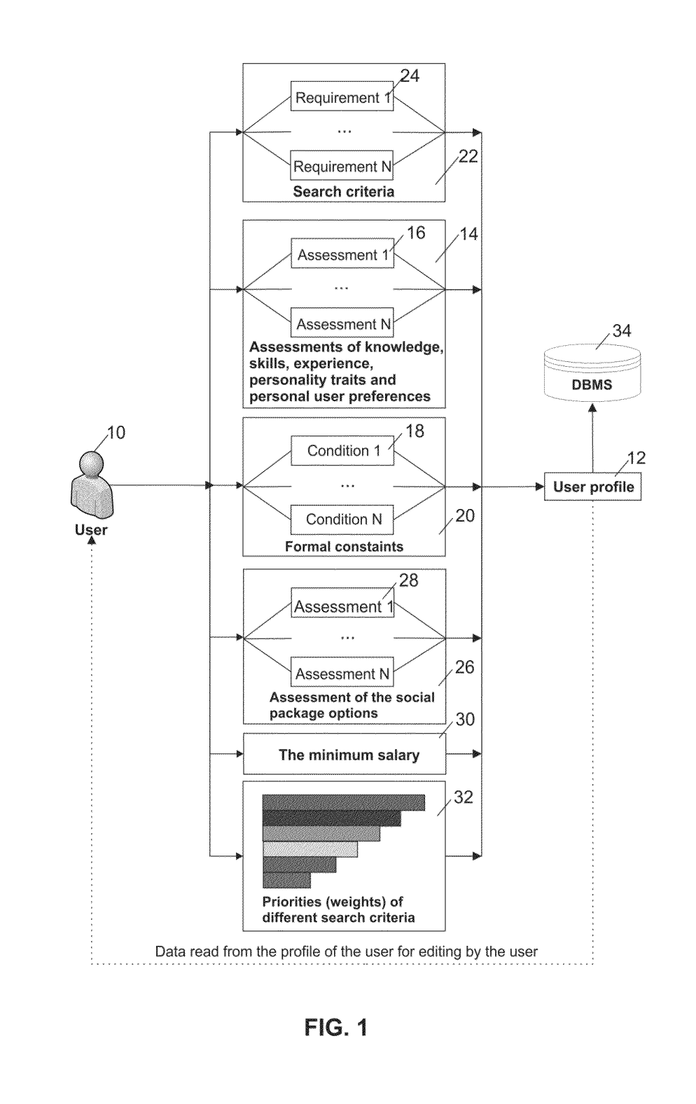

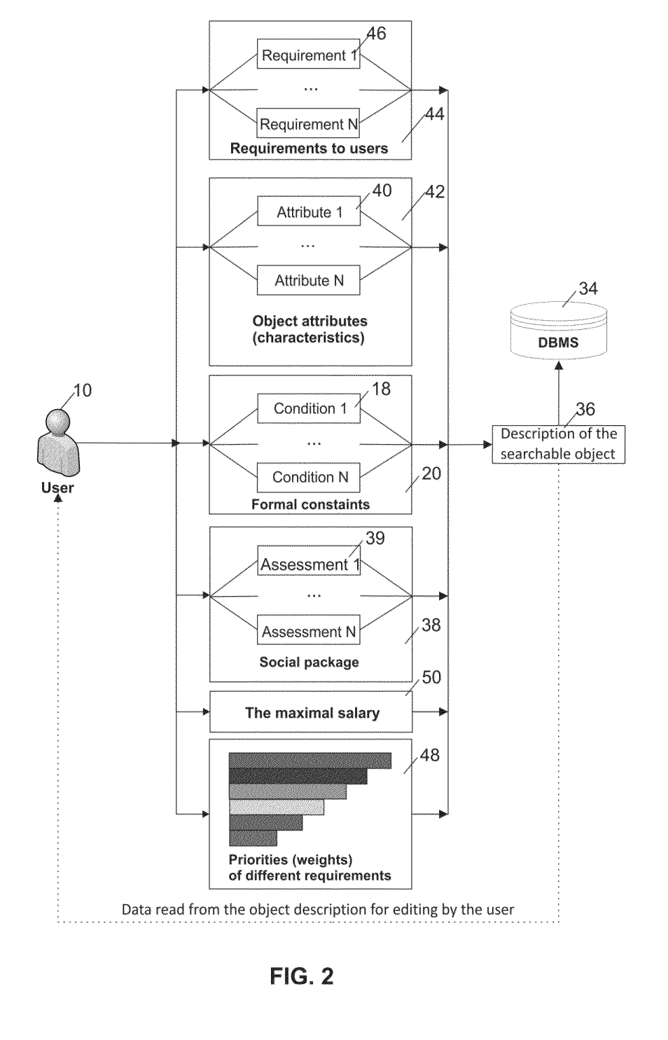

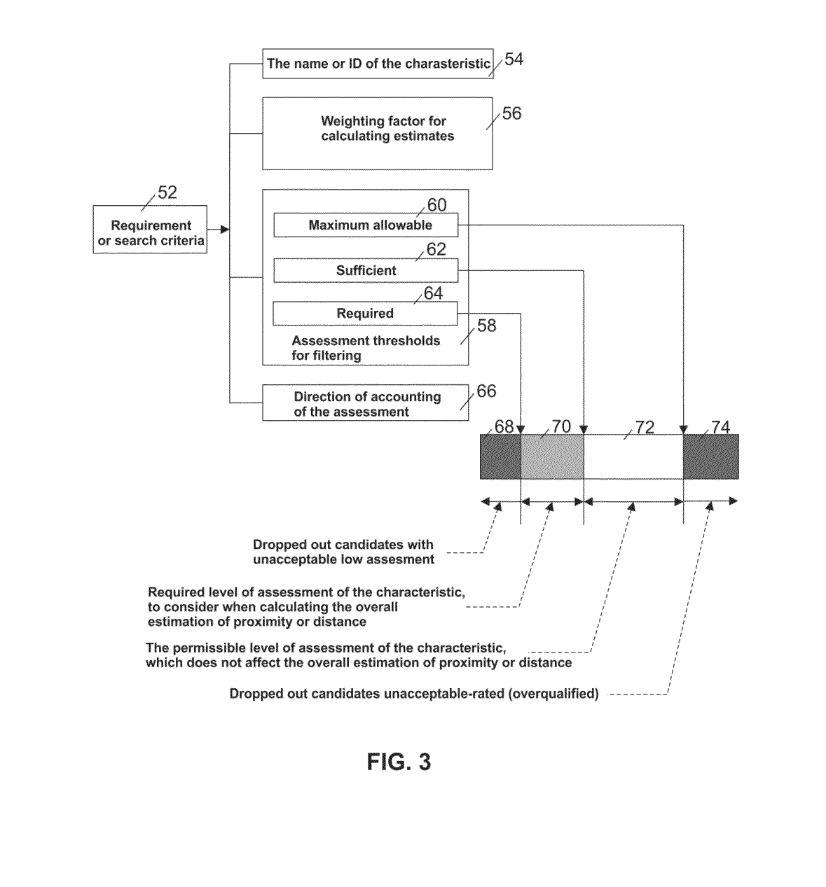

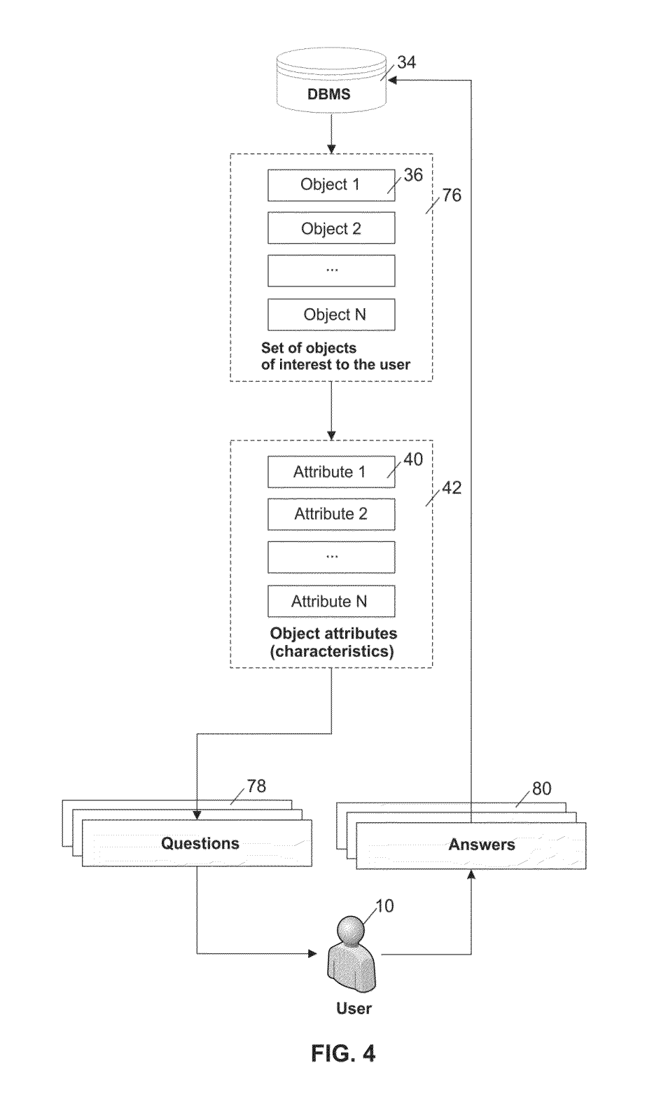

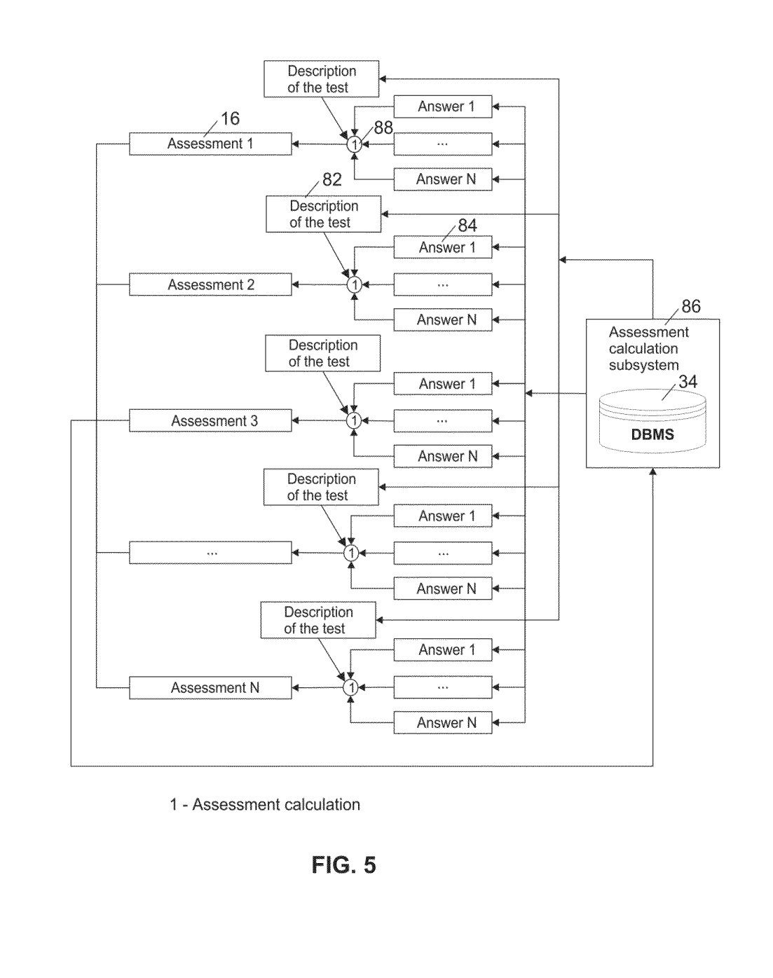

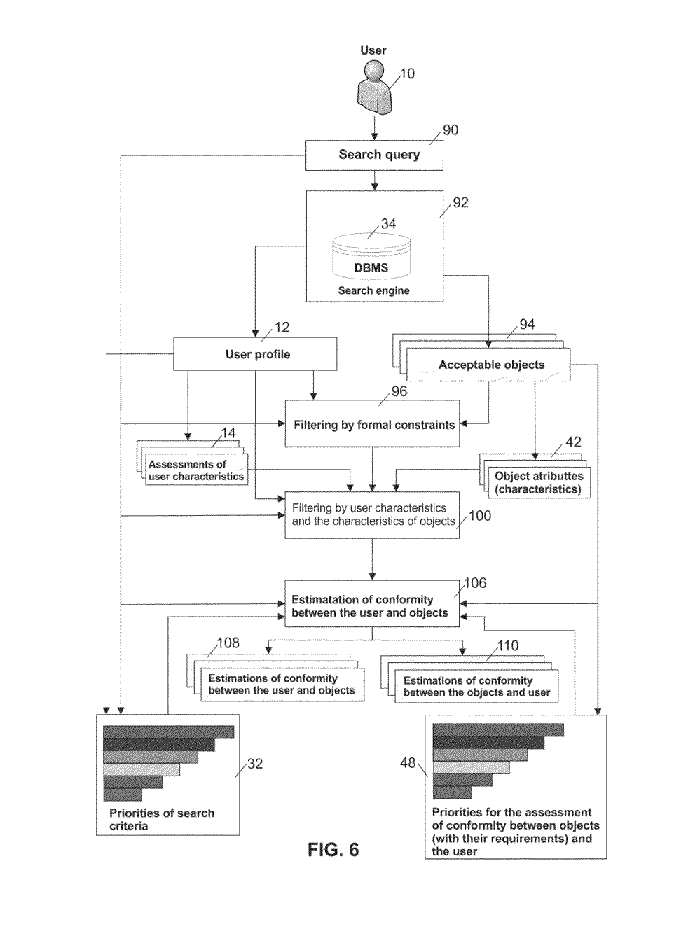

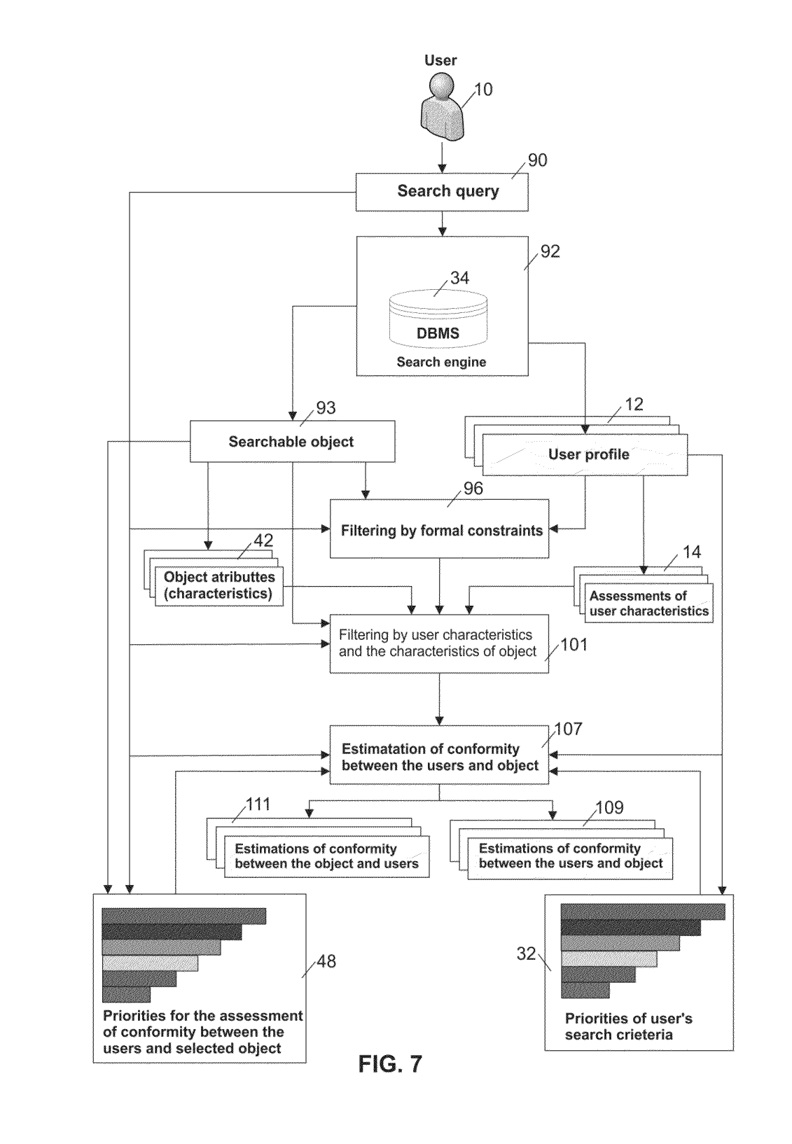

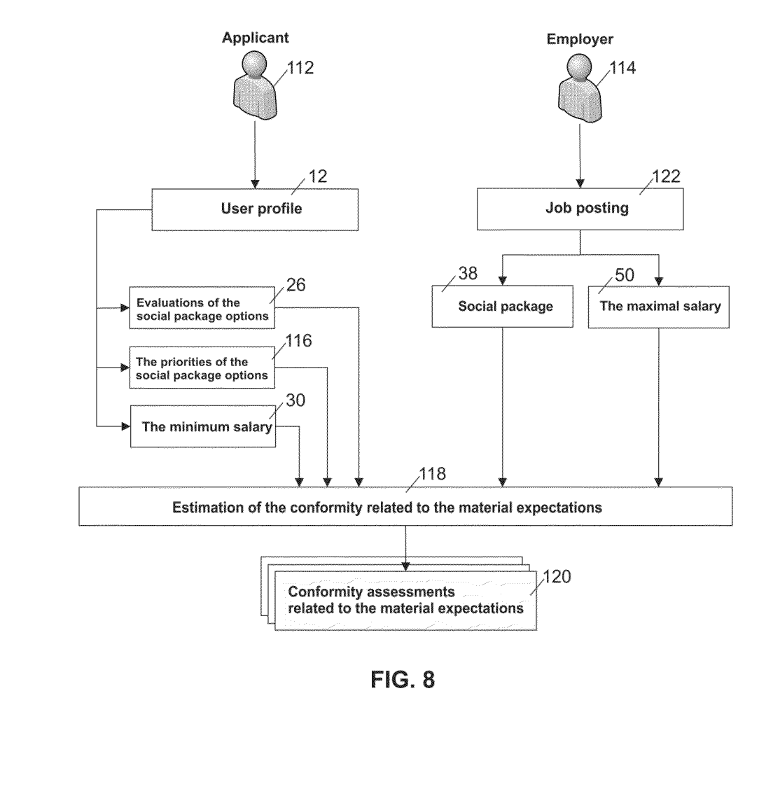

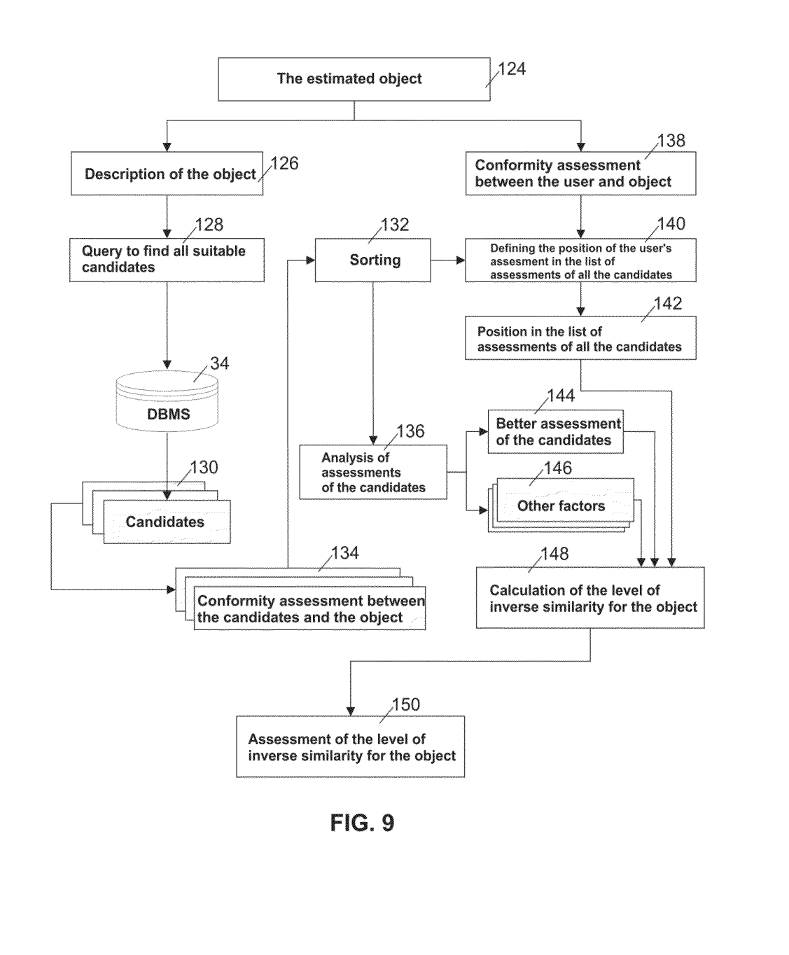

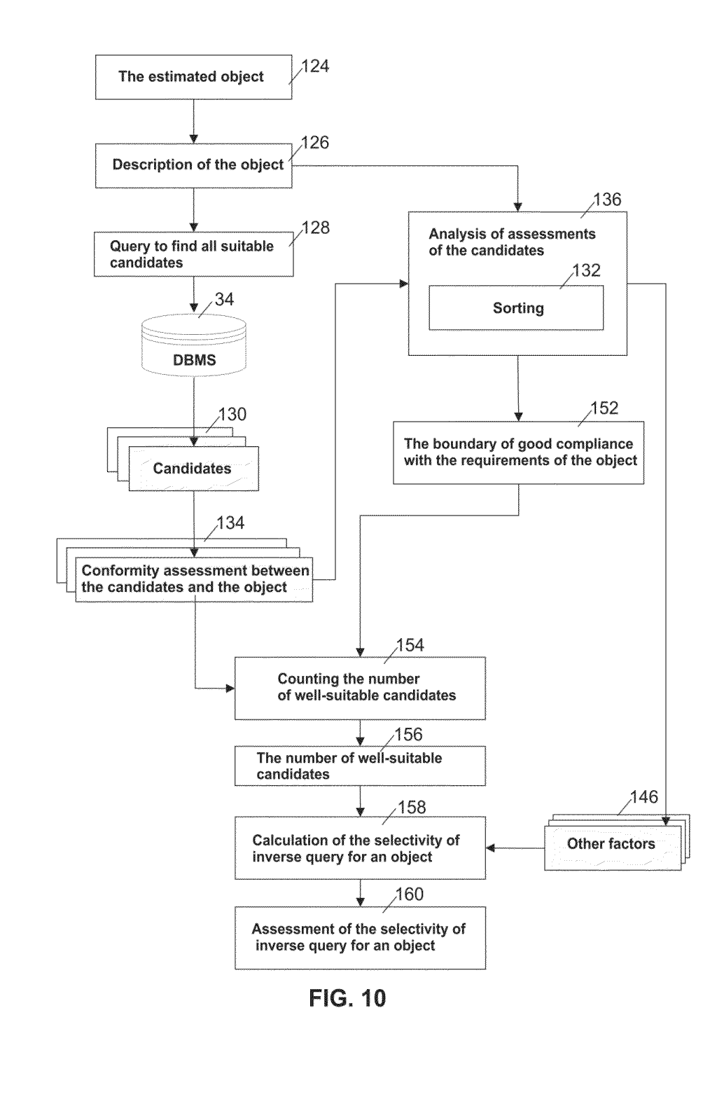

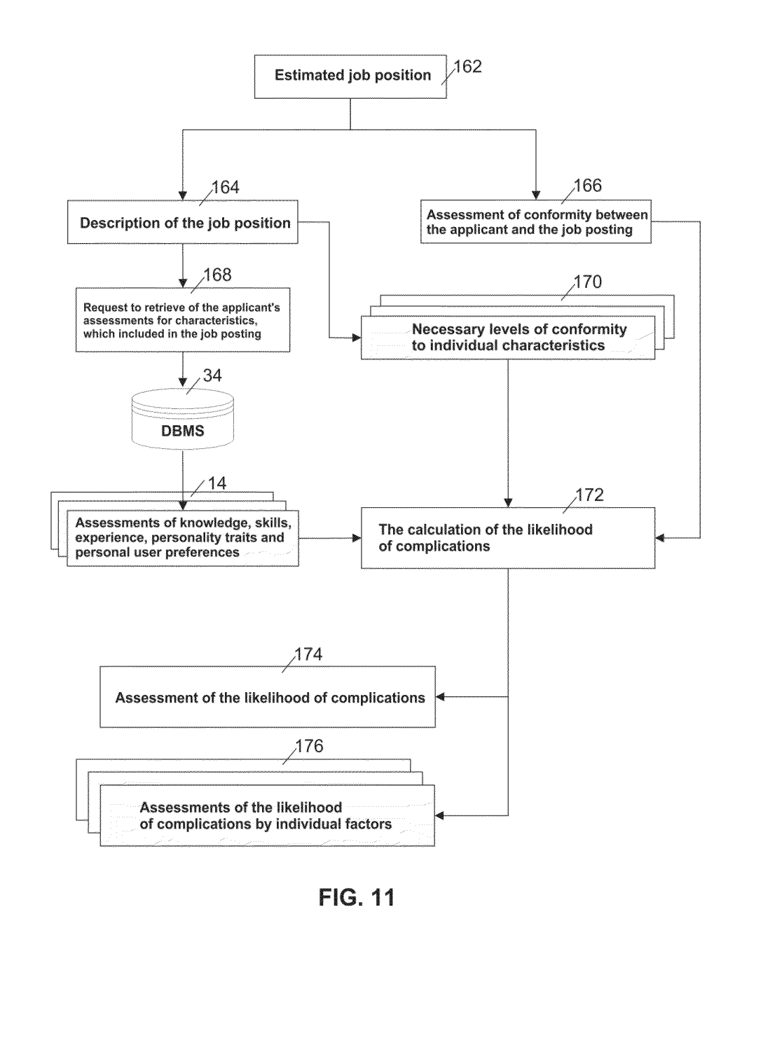

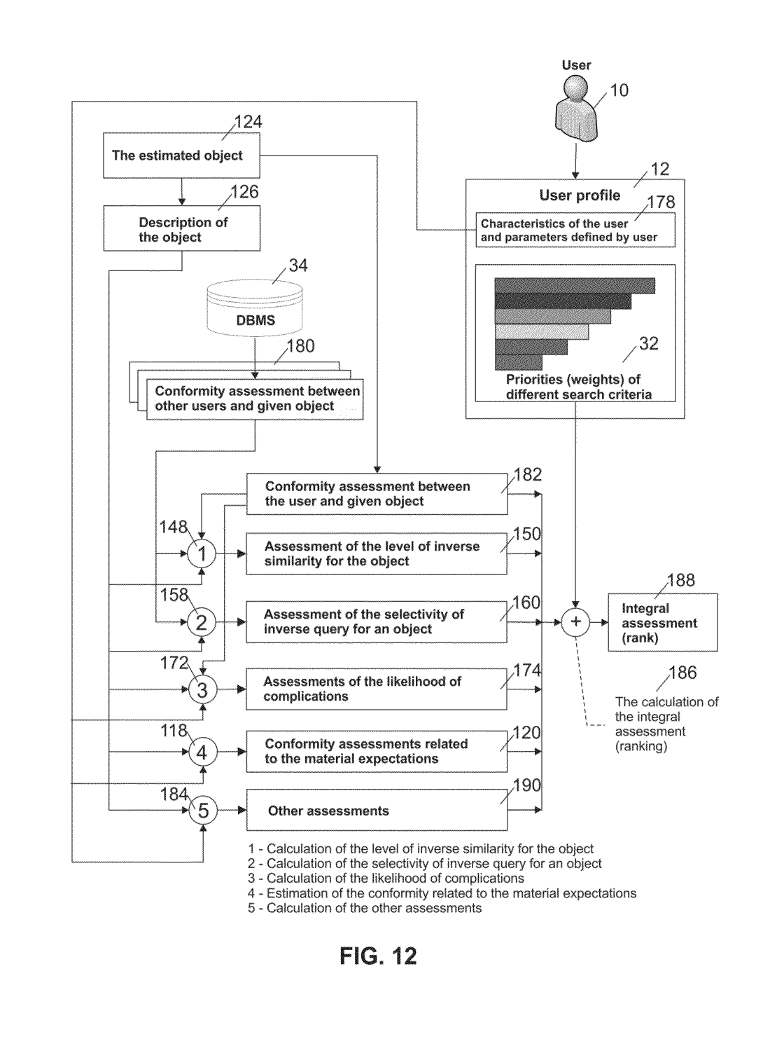

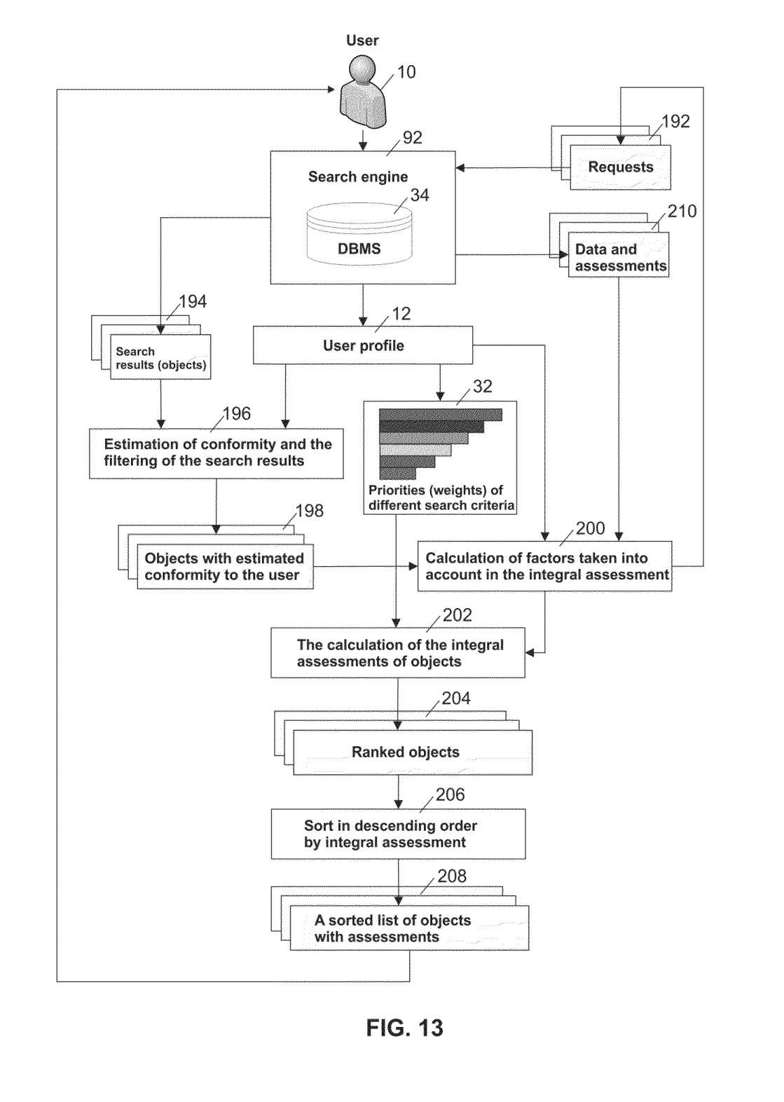

### CROSS-REFERENCE TO RELATED APPLICATIONS

Some claims of the present invention are a Continuation-In-Part of U.S. patent application Ser. No. US 2011/0016137, filed Sep. 11, 2007, and entitled “User proximity search system, method and API”, which is hereby incorporated by reference, and which claims the benefit of U.S. provisional patent application Ser. No. 60/843,823, entitled “User proximity search system, method and API” and filed on Sep. 11, 2006, disclosure of which is included herein at least by reference.

### COPYRIGHT NOTICE

A portion of the disclosure of this patent document contains material, which is subject to copyright and trademark protection. The copyright owner has no objection to the facsimile reproduction by anyone of the patent document or the patent disclosure as it appears in the U.S. Patent and Trademark Office patent file or records, but otherwise reserves all copyright and trademark rights whatsoever.

### FIELD OF THE INVENTION

In search engines whose objects may be ranked (ordered), for instance, in a database management system with a multifactor search, in social networks or on dating sites, where there is a search function for people, in search engines for job searches or filling vacancies, in content delivery systems, in targeted-advertising systems, in online trading systems, etc. the problem arises of how to order the search results according to criteria of how attractive the objects found are to the person, in whose interest the search was performed.

The “attractiveness” of the objects may be formally evaluated by different means, depending on the specific subject area. For instance, we can assume that the evaluation of attractiveness coincides with the evaluation of the similarity of the found objects to the expectations or preferences of the person, in whose interest the search was performed.

For instance, in employment search engines, which are based on the analysis of expertise, practical skills, experience and/or psychological characteristics of the applicant, it is necessary to be able to place the found vacancies in descending order according to their preference for the applicant.

From the point of view of the applicant, the vacancies differ strongly—different vacancies possess different levels of attractiveness, even if they formally fit him due to his qualifications.

The applicant does not wish to waste time in an interview with employers who have a high probability of not hiring him. He also does not want to worry, waiting for a long time for responses from such employers after sending them his resume or contact information. Furthermore, the applicant does not want to waste time looking through hundreds of job vacancies that formally fit him, searching for the most interesting and promising among them.

The vacancies must be ranked by the degree of their attractiveness to the applicant not only to move the uninterested vacancies to the bottom of the list (for example, those not appropriate to his professional level), but also to move to the top of the list those vacancies, which have the highest probability of providing employment.

Similarly, on dating websites and social networks there arises the problem of sorting dating candidates or suggested friends, found by a few criteria, to be listed in descending order of their attractiveness to the user who performs the search, for instance, in descending order of their similarity to the expectations and preferences of the user who performs the search.

We note that when ranking a set of found dating candidates it is necessary to consider their mutual similarity to the expectations and preferences of one another.

Typically the user is interested in the fact that, at the beginning of the list he sees the people with whom he/she has a high probability of successfully dating. However, he/she may waste a great deal of time on fruitlessly looking at profiles and on pointless correspondence with the very candidates who have a high probability of responding to him/her with rejection, or not responding at all.

Existing dating websites and social networks do not provide any means to sort candidates by the likelihood of a successful date with them. There is also no means of sorting by other high-level criteria or expectations, such as, for instance, by the probability that a candidate will switch his attention to another user for dating.

Existing dating websites and social networks do not allow the user to sort the query results by a wide array of parameters and assign priorities to these parameters, including, in part, the expectation of variables connected to the probability of successful dating.

This makes the utilization of dating websites and social networks rather ineffective, forcing the users to look through a set of profiles of unpromising candidates and/or to carry out hopeless correspondence and wait for responses which will never come.

In order to get to the people in the query results in whom they are really interested, users of current dating websites are forced to ineffectively waste money on the artificial raising of their profiles' rank in the very search query that causes their aggravation. He/she who spends a lot of money receives more chances than he/she who distinctly knows in what sort of candidate he/she is interested.

The problem of ranking a search query or any other set of objects by their attractiveness (by their similarity to expectations or preferences, by the probability of successful interaction with the found object, etc.) comes up in other areas, for instance, in trade, in advertising and in others.

This patent application describes a general framework for solving the problem of a multifactor search and ranking the query results or an arbitrary set of objects by high-level factors connected to their attractiveness according to preferences (priorities) assigned by the user. This includes a solution to the problem of sorting a list of found people, when it is necessary to take into consideration the mutual interests of the parties.

### BRIEF SUMMARY OF THE INVENTION

This patent application describes a system of multifactor search and a method of ranking results of the search query (or an arbitrary set of objects), which allows found objects (or elements of an arbitrary set of objects) to be arranged with respect to their attractiveness to someone (for instance, for a user, in whose interest the search query was performed) or with respect to their preference for participation in some process.

The ranking forms the basis of the present invention, and takes into consideration such factors as similarity to expectations or preferences of the user (including reciprocal ones), the probability of successful interaction with the found object (for instance, the probability of employment or successful dating) and other parameters, as these are only some, and others can be found beyond those given.

From here on, ranking a set of objects is to be understood as a direct reordering of the objects before they appear to the user, or before any further machine (computer) processing, and the calculation of new (or the recalculation of old) values of similarity (or distance) between objects (the calculation of their rank), for showing these new values of similarity (distance, rank) to the user or for their use in further machine (computer) processing, including when there is no actual rearrangement of the objects.

The ranking is performed through the use of methods, which are described in this patent application, and on the basis of variables, the calculation of which, or the principles and methods of calculation of which, are the essence of the given invention, and which may be interpreted as the ranks of the objects, their distance from a few base objects, or the values of similarity to a few base objects. In addition, the ranking may include arbitrary “external” parameters, the methods of calculation of which may be found beyond the scope of this invention.

Although for the description of this method it is more convenient to use the terminology of search queries, and the ordering of search queries in different interactive systems is one of the most important applications of this patent application, nevertheless, we strongly emphasize that the described methods and their principles may be applied in equal measure to the ranking of an arbitrary set of objects (to their order, the calculation of object ranks, their distance from a few base objects or the evaluation of similarity to a base object).

For example, the described methods may be applied to the ranking of a selection from a database made by a query from a computer program, or to the ranking of a set of objects of a defined class, which are saved in a database or in a computer's memory—even if no one searched for these objects in a search query.

In particular, the described method allows the evaluation of the probability of employment for a given applicant and expresses this value quantitatively. In this way, it allows all the appropriate vacancies to be placed in descending order of probability of providing employment. Conversely, the described method allows the distribution of applicants in descending order of probability that they will be employed by a given employer.

Also, in particular, the described method enables the evaluation of the probability of successful dating for dating websites or social networks and expresses this value quantitatively. In this way, it allows the ordering of candidates for dating in descending order of probability of successfully dating them. The described method takes into account the interests of both parties in the search for a partner, not merely the interests of the user conducting the search.

An important difference between the patented method of ranking and other systems for ranking search query results is the utilization of ordering the found objects by the probability of mutual interest or similarity.

In particular, the relative position of the interested user (or the object, similarity to which defines the preference of found objects) among a real or fictitious list of users (or other objects) interested in the given query result, which rank is under evaluation (or similar to the given object, which rank is under evaluation) may be used for the measurement of probability of mutual interest or similarity.

This idea is illustrated in the following example.

Let us suppose that in the employment search engine we need to sort vacancies, which are appropriate for a given applicant. Suppose that we apply a certain method of calculating the values of accordance (similarity) between vacancies and applicants, and determine that a given candidate corresponds to the criteria of the first vacancy by 67% (in comparison with a hypothetical ideal candidate for the given vacancy). However, the candidate corresponds to the criteria of the second vacancy by 80%.

Current systems symmetrically use this evaluation not only to define the list of best candidates for a given requirement on behalf of the employer, but also to show the found vacancies to the applicant. As a result the candidate sees that the vacancy, for which his level of accordance (similarity) is 80%, is at the top of the list, and the vacancy to which he/she is 67% suitable is after that.

The method described in this patent application computes the values (ranks) of the found objects differently. It raises to the top those vacancies, which have a higher chance of employment.

To evaluate the chance of employment, our system defines the position each applicant occupies in an ordered list of different candidates, who are appropriate for this vacancy.

If, for example, for the first vacancy (to whose criteria the candidate is suitable by 67%) the given applicant is the very best candidate (the first in a list of candidates for this vacancy), and for the second vacancy he/she is 100th among the other candidates, then, despite the fact the his/her level of accordance (similarity) to its criteria is 80%, the patented method does not lift this vacancy to the top.

It displays the vacancies in ascending order according to the position a given applicant occupies among the list of all candidates for each vacancy. Because this position defines the chance of employment, it signifies the preference of a given vacancy for an applicant.

Despite the fact that the candidate is more suitable to the criteria of the second vacancy, he/she possesses minimal chances of being employed, since he only ranks as the hundredth on the list of best candidates. The employer with a high probability in general would not pay attention to him/her. Accordingly, this vacancy will receive a much lower final evaluation, which produces the sorted list of found vacancies and/or is shown to the user.

The second key idea of this patent application is the provision to the user of the search engine interface, with which he/she may select criteria, by which the system subsequently ranks the results of the search query, and assigns them weights.

For instance, in selecting the criteria, the user may arrange them in descending (or ascending) order of importance or by another method assign a weight to each criterion. In this way, the user has the ability to specify not only the limits of the selection, but also, in a clear way, communicate to the search engine his/her own priorities and preferences for sorting the found objects.

Other search engines allow the user to specify his/her search criteria for selecting the objects, but they do not allow him/her to enumerate in descending (or ascending) order of importance of his/her priorities and preferences for sorting the received results, or by other rules, or by methods obvious to user, to manage the priorities (weights) of his/her requirements.

Also, part of the given invention is the original method of quantifying the value of similarity of users (on social networks, on dating websites and etc.) by their interests.

Furthermore, we are patenting methods of identifying search spam and user errors in preparing search queries.

In this patent application we are defending the scheme, algorithms and methods of the original search system, the basic application of which is this search for people, including simultaneously by a few criteria of differing importance, taking into account the mutual interests of parties and the personal preferences of individuals. Nevertheless, this system may also be used to solve other problems besides searching for people.

### BACKGROUND OF THE INVENTION

The precise automatic evaluation of the level of similarity of an object found by the search query to the expectations and preferences of a person, in whose interest the query was performed, is, in general, impossible.

With the aid of his intellect, a person may informally analyze the found objects and approximately rank them by the level of similarity to his expectations and preferences, intuitively understanding the problem of selecting one out of a few objects. Often this evaluation or selection is made through the consideration of a few of such informal criteria as “beauty”, “interest” or “potential”. The evaluation or selection may change, depending on the mood of the evaluating person. When there are many found objects, the evaluation, as a rule, will not be faithfully reproduced (exactly) in a series of experiments.

At the same time, in many practical applications, the results of a search query may be numerous, consisting of hundreds, thousands or even millions of formally appropriate objects. A person is not able to keep in mind and qualitatively rank such a quantity of objects, unless he spends a great deal of energy and a great amount of time on step-by-step selection and ranking, which makes working with query results very ineffective.

Fortunately, in many applications there are formal criteria, which correlate with a person's preferences (although they may not coincide with them exactly). An automatic sorting of search query results by such correlating criteria helps a person to spend significantly less effort when examining search results.

If the level of correlation is high, for example, when the whole set of correlating factors is taken into account; the quality of automatic ranking may become significantly higher. The person can limit his/her consideration of selections to only the top of the sorted list of found objects, disregarding the low probability that he might miss something important due to suboptimal automatic ranking.

If a person is able to work with only the top of the list of found objects, then the efficiency of his work with query results increases many times over.

The aim of the methods described in this patent application is to ensure a sufficiently high quality ranking of the query results on the basis of formal criteria, which possess a high correlation to the value that a person gives informally.

For instance, lacking the possibility to reliably define the significance of informal factors and their influence on making decisions about employment, we are nevertheless able to, with a sufficient degree of certainty, forecast the final value of accordance (similarity) of a vacancy to the expectations and preferences of an applicant, so that there is a high correlation between the informal factors, which the human brain analyzes, and the ranks of formal criteria, which describe the vacancy and the candidate.

In particular, in this patent application the methods are described, which allow the formalization and approximate evaluation of formal factors that influence the attractiveness of a vacancy, give a quantitative value to these factors and calculate a weighted value for the vacancy from the sum of all the factors (for sorting the list of vacancies by the degree of their preference for a given applicant).

Similarly, we solve the problem of ranking candidates on a dating website or social network, as well as other problems of ranking query results by the preference of found objects or the potential for interaction with them.

### BRIEF DESCRIPTION OF THE DRAWINGS AND A GENERAL DESCRIPTION OF THE SEARCH ALGORITHMS

General Scheme of the System

In this section there are detailed descriptive drawings, which illustrate the structure of the multifactor search engine, which uses the ranking method from this patent application and other methods, which make up the essence of the given invention. Further, in the section “Error! Not a valid bookmark self-reference.”, these methods and algorithms are described in detail.

Also, to avoid redundancy and inconsistencies in this section there is a general description of the algorithms and working steps of the search engine, presented in this invention. These descriptions clarify the purpose of the units in the figures, describe the behavior of the system as a whole, and complement the detailed description of the invention.

The scheme of the multifactor search engine and the basic functioning units, which comprise the patented methods, are shown in an example application, in which a search of arbitrary objects is carried out in the interests of a user.

For instance, this may be applied to a job search, which selects vacancies, which are of interest to a given applicant.

On the other hand, we can consider the searched objects as users themselves, in which case the presented schemes may be used as schemes for a search engine for people on a dating website or social network.

The patented method may be used in multiple other applications, a few of which are examined in detail in the section “Error! Not a valid bookmark self-reference.”.

The schemes of the system for different applications coincide exactly with the schemes shown here, up to the replacement of a few terms and the addition of supplementary modules specific to the exact subject area, which a specialist skilled in the art could perform.

For instance, by substituting a description of tourist trips (cruises, for example) in place of user profiles (in our schemes), and substituting profiles of potential clients in place of the search, we end up with a system, which is designed for travel agents, and allows them to select those clients who have the highest interest in a given tourist trip.

By taking into account the mutual consideration of client preferences and the opportunities provided by each tour, the system qualitatively lowers the probability of a client rejecting the offer presented to him by the travel agent.

A specialist skilled in the art could easily create other similar changes to terms, and could also add to the system supplementary units, creating schemes for very different systems (specific embodiments), utilizing the universal methods and principles, which make up the essence of the given invention.

Input the User Profile

Drawing 1 presents the process of input by the user (for example, an applicant, a user of a social network or of a dating website) of critical data for his profile in the patented search engine. The input process is followed by saving the user profile in the system's database.

The user profile may contain the following important, from the point of view of our search engine, information:
The values of different attributes (characteristics), inherent to a given user: values of his skill level or amount of knowledge, values of experience, values of personal psychological characteristics of the user, his personal preferences (for example, assigned according to the evaluation or ranking of certain objects: films, books, etc.). In a few applications this information is not entered by the user directly, but is calculated by the application itself on the basis of the results of a user test, or is gathered from external sources.
Formal limits to the search. For example, the region in which the user searches for friends or employment, or the type of employment of interest to him (during a job search) etc.
In the specific application of a job search, values, which the user defines, of a benefits package. Subsequently they are used in the calculation of similarity between vacancies and the tangible expectations of the applicant, as described in the section “Similarity of the vacancy to the tangible expectations of the applicant”.
In the specific application of a job search, an acceptable minimum wage. Subsequently this is used in the calculation of similarity of a vacancy to the tangible expectations of the applicant, as described in the section “Similarity of the vacancy to the tangible expectations of the applicant”.
The priorities of the factors, which are used to rank the found objects. For instance, this may be a list of factors for ranking found objects, where the factors are numbered in descending order of significance. These priorities are subsequently used in the calculation of integral values of found objects (their ranks), as described in the section “Calculation of integral value” in the detailed description of the invention. They may also be used in the calculation of the level of inverse similarity, which is examined in the section “Level of inverse similarity” and in the relevant sections dedicated to specific embodiments.
A description of the search query or an enumeration of requirements for the search objects, which are of interest to a given user. The scheme of requirements is discussed in detail in the description of drawing 3.

Input Description of the Search Object

Drawing 2 presents the input process for describing the search object in the patented search engine, which results in the description of the search object being saved in the system's database.

If the search engine is intended to search for people who are mutually interested in one another (for example, a social network or dating website), then this step may coincide with the input of the user profile (as shown in drawing 1 and described in the previous section), in this case the search objects are also users.

In general, the description of a search object includes the following information of interest to the described system:
A description of the search query or an enumeration of the requirements for people who are similar to the given search object. The scheme of requirements is examined in detail in the description of drawing 3.
Formal limits. For example, there may be limits by region, in which a user interested in the given object must live, or limits by type of employment (in applications for finding employment) etc.
In the specific application of searching for employment, the maximum salary which the employer is ready to pay for the vacancy. This is subsequently used in the calculation of the similarity of the vacancy to the tangible expectations of the applicant, as described in the section “Similarity of the vacancy to the tangible expectations of the applicant” in the detailed description of the invention.
The priorities of the factors, which are used to rank appropriate users who will be interested in the given search object. For example, this may be a list of factors for ranking found users, numbered in descending order of their significance. These priorities are subsequently used in the calculation of the integral values of the users (their ranks), as described in the section “Calculation of integral value”. They may also be used to sort a list of users in inverse queries, which are examined in the section “Level of inverse similarity” and in the relevant sections dedicated to specific embodiments.

Description of Requirements, Entered into the Search Query, User Profile, or Search Object

Drawing 3 describes the scheme for describing individual requirements, whether entered into the search query, indicated in the user profile, or included in the description of the search object. Drawing 3 may be considered a clarification for drawings 1 and 2, as well as to a number of other figures.

The requirements entered directly into the search query, requirements for the search objects indicated in user profiles, and requirements for users indicated in the descriptions of search objects, may include the following information:
A name, identifier or other reference to a characteristic (trait), on which the given requirement is based. This might be a name, identifier or other reference to the areas of skill, knowledge, experience, personal psychological characteristics, or personal preferences, which form the basis of the given search requirements.
A weight coefficient, which evaluates the contribution of a given characteristic to the general similarity value of the user to the search object (or of the search object to the user).
Threshold values for the given characteristic (the minimum and maximum acceptable level for the value), used in filtering out (screening) users or search objects whose value for the characteristic does not fall within the designated range.
An appropriate value for the given characteristic, above which the given variable ceases to further influence the similarity value between the user and the search object.
An indicator, assigning the direction along which to consider the value of the given characteristic. This indicator shows whether significant characteristics should be interpreted as increasing or as decreasing the general similarity value between the user and the search object.

The requirements are important for the calculation of preliminary (not including the ranking described in this patent application) similarity values between users and search objects, for example, for calculating the similarity values between applicants and vacancies or for calculating the similarity values between people on dating websites and social networks.

The preliminary (received before ranking the query results) similarity values between users and search objects are then used in the calculation of different factors in the detailed description of the given invention, described (among others) in the sections “Level of inverse similarity”, “Selectivity of inverse query” and in the relevant sections which describe specific embodiments.

Process of Testing the User

Drawing 4 illustrates the process of user testing, which is designed to determine the significance of his characteristics, that is, the user's values for personal traits, such as level of skill, knowledge, work experience, and values of his personal psychological characteristics, or, for example, his personal preferences.

As was mentioned earlier, the description of each search object (for example, vacancies in the application of finding employment) includes a set of requirements, which are presented to the user: his skills, knowledge, experience, personal psychological characteristics or personal preferences.

Each such requirement may be associated with a test or survey, which presents a set of questions, which the user answers in order for the system to calculate his value for the given characteristic.

The system determines which questions are appropriate to show to the user, extracting from the search query and from the descriptions of search objects information about the traits (characteristics), included in the requirements of the search and/or mentioned in the inverse requirements of the search objects.

After this the system finds tests or surveys associated with these characteristics. The questions in the tests and surveys are presented to the user, who then answers them.

The user's answers are saved in a database.

Process of Evaluation Similarity of the User to Individual Requirements

Drawing 5 presents one of the most important implementations of the process of calculating the significance of user characteristics.

The value of a characteristic is calculated after receiving new answers to the questions, in real time or later.

To this end, the user's answers to test questions, connected to the individual traits of a given user, are compared with the correct answers, taken from the descriptions of the test. The significances (values) of the user characteristics are calculated and refined according the results of these comparisons.

The significances of user characteristics (values of their traits) are saved in the system's database. They may also be saved in RAM, without actually being written to the database as a permanent repository.

The details of the process of calculating the values of individual characteristics (details of the process of defining the characteristics) make up an inessential part of the given invention, which utilizes the very existence of the characteristics (the values of traits of the user or the search objects), but are only some of the possible applications.

A specialist skilled in the art can apply the similar process to define the characteristics of other search objects (not only characteristics of the user).

Process of the Search and Primary Evaluation of Objects Requested by the User

Drawing 6 presents search process for objects requested by the user, including the process of calculating the preliminary similarity value between found objects and the user.

First the system selects those objects that satisfy the formal limits taken from the user profile and/or from the search query.

For example, in the application for finding employment, the formal limits might include the region in which the user is seeking work. Search objects (vacancies) offering work in a different region is known to be irrelevant to the user, and are accordingly discarded.

After this, the system compares the remaining characteristics of the objects with the limits of the requirements for the objects taken from the user profile and/or from the search query. The system discards those objects whose significances of characteristics are found to exceed the limits defined by the search query or the user profile.

Next, the system calculates either anew or receives from a database the values of personal characteristics of the user (the significance of his characteristics) for those characteristics, on which the requirements are based in the descriptions of the search objects.

Next, the system verifies that the user's values satisfy the constraints that apply to the individual traits (the significance of his characteristics), which were indicated in the requirements in the descriptions of the found objects. As a result a portion of the objects are discarded when the user does not meet the requirements indicated in the descriptions of these objects.

A specialist skilled in the art may freely transpose these steps with inspections of the limits, described above and/or (in part or in whole) combine them with the following step.

If the values of the user characteristics or the object characteristics are calculated in the search process, then they may be counted, for example, by the algorithm described in drawing 5.

Using the values of personal characteristics (traits), either comprising the search query or indicated in the user profile, the preliminary (not including the ranking, described in the given patent application) value of similarity between the user and the search object is calculated, as well as the preliminary value of similarity between the object and the user. In the general case, these two values are not the same.

These values of similarity are then used in the calculation of many different factors examined in detail in the detailed description of the given invention, in the sections “Level of inverse similarity”, “Selectivity of inverse query”, and in the relevant sections dealing with specific embodiments.

The details of the process of calculating the values of similarity between users and search objects are not an integral part of this invention, which uses the values. Accordingly, a specialist skilled in the art may replace this part of the system with another implementation.

Process of Search and of the Preliminary Rank of the Users, for Whom the Given Object is Appropriate

Drawing 7 presents the search process for users, for whom the given object is a good fit.

This process defines the inverse query in relation to the process explained in drawing 6 and described in the previous section, and is analogous in design to it, up to changing the base and search objects.

For example, in a search engine for employment this may be a search for applicants, for whom a given vacancy is a good fit, initiated by an employer.

Process of Evaluating the Similarity of a Vacancy to the Tangible Expectations of the Applicant

Drawing 8 presents the process of calculating the similarity value of a vacancy to the tangible expectations of an applicant, specific to embodiments connected with systems of searching for employment.

This process includes a calculation of similarity between the expectations of an applicant about salary level, and the salary actually offered by an employer.

To this end, the variable of acceptable salary is calculated from the user profile, and the variable of offered salary is calculated from the description of the vacancy provided by the employer.

Also, the process of evaluating the similarity of the vacancy to the tangible expectations of the applicant includes calculating the level of similarity between users desiring a benefits package with packages that are actually offered by employers.

To this end, the values of benefits packages are taken from the user profile, or a list of packages is ranked by importance, or information about benefits packages actually offered by an employer for a given vacancy is gathered from the description of that vacancy.

This process and the formulas used in the calculation of similarity values are described in detail in the section “Similarity of the vacancy to the tangible expectations of the applicant” in the detailed description of this invention.

Similar processes (up to the replacement of terms in the scheme and the addition of complementary units, which a specialist skilled in the art could easily perform) may be used in content delivery systems, in selection of products (e-commerce), in targeted advertising, etc.

Process of Determining the Level of Inverse Similarity

Drawing 9 presents the scheme of the process of determining the level of inverse similarity for an individual object by using the values of similarity for one of the objects.

To define the level of inverse similarity the system searches a database of users, for whom the given object is a good fit, calculates their similarity values to the given object and sorts the list of found users in descending order of their values.

For example, in a search engine for employment this may be a sorted list of applicants, meeting the requirements of a given vacancy.

Next the system searches the sorted list for the given user, in whose interest the search query was conducted (or defines the position, which his value occupies among the values of other candidates) and on the basis of this variable, the level of inverse similarity is determined.

The level of inverse similarity may also be determined by using the value of the best of the found candidates and other variables, obtained in the analysis of the list of appropriate users.

A specialist skilled in the art could easily change the terms on elements in the scheme and obtain a similar scheme of a process, which determines the inverse query by calculating the level of inverse similarity for the user (in relation to a specified target object).

The semantics of the level of inverse similarity, the process of calculating this variable the application of the calculated value are discussed in detail in the sections “Base factor for ranking”, “Level of inverse similarity” and in the relevant sections describing specific embodiments.

Process of Determining Selectivity of the Inverse Query

Drawing 10 shows the scheme of the process of defining the selectivity of the inverse query for an individual search object, using the values of similarity between the object and users, for whom the object is a good fit.

To define the level of inverse similarity the system search the database of different users, for whom the given object is a good fit.

Then the system calculates their values of similarity to the given object, analyses these values, and defines the limit of a good fit for the requirements of the given object. The limit of a good fit may also be taken from the description of the object, if the practical implementation of the system provides such a configuration.

Next, the system either precisely calculates or estimates the quantity of users whose values of similarity are higher than the found limit of a good fit, and on the basis of these variables, the value of the selectivity of the inverse query is determined.

To define the limit of a good fit, and to calculate the value of selectivity of the inverse query, the system may also utilize other variables obtained in the analysis of the list of appropriate users.

A specialist skilled in the art could easily change the terms of the elements in the scheme and obtain a completely identical scheme for the process of finding the selectivity of the inverse query for a user (in relation to a given target object) instead of the calculation of the selectivity of the inverse query for an object (in relation to a given user).

The semantics of the value of the selectivity of the inverse query, the process of calculating this variable, and the application of the calculated value are discussed in detail in the sections “Selectivity of the inverse query”, “Job security” and in the relevant sections dealing with specific embodiments.

Process of Evaluating the Probability of Encountering Difficulties in Work or Relationships

Drawing 11 presents the scheme of the process of evaluating the probability of encountering difficulties at work using the values of applicants in individual attributes, which make up the requirements of the vacancy, and also using the value of general similarity of the applicant to the vacancy.

An identical scheme, up to the replacement of terms, which a specialist skilled in the art could easily perform, may be used for the probability value of encountering difficulties in relationships, for instance, for use on social networks or dating websites. The given invention may also be used to assess the probability of complications in other systems and processes.

To evaluate the probability of encountering difficulties at work, the system retrieves from the database the values of the individual in different characteristics, which are required by the given vacancy.

Then the system calculates the baseline of necessary similarity to given requirements from the description of the vacancy given by the employer.

Using this information, the system defines the distance, for individual characteristics, between a given applicant and a virtual candidate with the baseline level of fulfilling the requirements for a given vacancy (for those requirements, which specify the minimum acceptable level of compliance) or with an ideal level of compliance (for those requirements, for which the employer did not specify the minimum acceptable level of compliance).

Based on this information, the system calculates the probability value of encountering difficulties in work, both for the vacancy as a whole, and by each individual characteristic, which make up the requirements.

This process is examined in detail in the section “Probability of encountering difficulty at work” in the detailed description of the given invention and in the similar chapter “Probability of encountering difficulty in relationships”.

Process of Calculating the Integral Value of the Object

Drawing 12 presents the process of calculating the integral value of the object based on the similarity to the preferences of the selected user, that is, the process of ranking individual objects through the use of the method described in this patent application.

The integral value of the object is formed, according to priorities, defined by the user, from the following factors:
Initial values of similarity of the object to the requirements of the given user (value of similarity to requirements, indicated in the search query or in the user profile) and the similarity of the user to the requirements, set for the object (indicated in the description of the object). In general, these two values do not coincide with one another;
Value of the level of inverse similarity (for example, the probability value of being hired for a given job when applied to job searches, the probability of successfully dating when applied to dating websites and social networks etc.);
Value of the selectivity of the inverse query (for example, the value of job security and the presence of a combination of rare characteristics in a vacancy in applications for job searches, the value of the ease of shifting attention to another candidate in applications for dating websites and social networks etc.);
Value of similarity of a vacancy to the tangible expectations of an applicant in applications for job searches or analogous variables in other applications;
Probability of encountering difficulties at work in applications for job searches, the probability of encountering difficulties in relationships in applications for dating websites or social, or analogous variables in other applications;
Other values, specific to the given application.

The process of calculating the integral value, that is, ranking, is discussed in detail in the sections “Calculation of the integral value for ranking a set of objects” in the detailed description of the given invention.

Analogous processes (up to the replacement of terms in the scheme, the addition of complementary units, which may easily be implemented by a specialist skilled in the art) may also be used in content delivery systems, in product selection (e-commerce), in targeted advertising, etc., and also for finding the “backward” integral value of the user's similarity to the indicated object (for example, for calculating the integral value of similarity between an applicant and a given vacancy in applications for job searches).

### Process of Ranking Query Results

Drawing 13 presents the general scheme of the process of ranking query results (list of found objects) according to the priorities set by the user, through the use of the methods described in this patent application.

The user accesses the search engine to search for objects. The search engine considers the user profile and finds objects, which fit the formal criteria of the search, such as, for example, the region, in which the user interested in the given object ought to live.

Next the system calculates the similarity values of the found objects to the requirements of the user, in the interest of whom the search was performed, and also discards those objects, which are not similar to the requirements of the search query and/or the requirements indicated in the user profile. In a similar way, the system calculates the similarity values of users to the found objects and discards those objects, whose requirements to the user, in whose interest the search was performed, fails to meet.

The preliminary selection of objects, the filtering by formal criteria, the process of calculating the similarity values of the object to the requirements of the search query or of the user and filtering by similarity to the requirements of the employer were discussed in detail above, and illustrated in drawing 6.

Then the system uses the evaluated objects, data retrieved from the user profile, along with other information, which is requested from database, to calculate the different factors (values), which were discussed in detail above and illustrated in drawings 8, 9, 10 and 11. Other factors may also be considered, which are specific to a given subject area or to a specific implementation of the search engine.

Using the significance of these factors (values) and by considering user priorities, the system calculates the integral values of objects, as was described in detail above and illustrated in drawing 12.

Ranked objects are sorted in descending order of their ranks (integral values) and the sorted list of objects is returned to the user and may be, for example, displayed on a screen or on a web page. As a result the user receives a list of objects in descending order of their attractiveness to him.

An analogous scheme (up to the replacement of terms in the scheme or the addition of complementary units, which may easily be implemented by a specialist skilled in the art) may be used to resolve “inverse” task of ranking users, for whom the selected object is a good fit.

### DETAILED DESCRIPTION

Base Factor for Ranking

The basic criterion by which the patented method ranks found objects in the search query results, or any other set of objects, is the relative position of the interested user (or of the object, similarity to which defines the preference of the ranked object) in a real or fictitious ordered list of users (or objects similar to the given ranked object).

For instance, if the search query searches for objects of interest to a few people, then we are interested in the position of the person (in whose interest the search query was performed, the results of which we are ranking) in relation to other people, for whom the object from the query results (the rank of which we now define) is also a good fit.

Conversely, if the search query searches for people who are interested in a certain object, then we are interested in the position of the given base object in relation to other similar objects, which are good fits for the found person whose rank in the query results we now define.

For instance, if we search for vacancies that are appropriate for a given applicant, then we are interested in the position that the applicant occupies in the list of best candidates for each of the found vacancies.

If we are searching for customers for a few goods or services, then we are interested in the position of the given good or service among other goods and services, which are appropriate to each of the found potential customers.

If it is necessary to find women on a dating website who are the best fit, according to their interests, to a given male user, then it is necessary to define the position of this man in the sorted list of potential candidates for dating of each of the found women. Furthermore, each woman's list of potential candidates (from which it is necessary to find a given man) may be sorted by their own individual criteria.

By using the exact value of this position or approximating the variable, this method defines the base factor of ranking as the level of inverse similarity.

Level of Inverse Similarity

The level of inverse similarity indicates the degree to which the user, in whose interest the search was performed, or some other object, similarity to which defines the preference of the ranked object, is mutually (inversely) similar to the object, found in the query results (or to the element of the set, which it is necessary to rank). We will call this variable “B”.

We will call the user, in whose interest the search was performed, or some other object, similarity to which defines the preference of the ranked object, the base object. The search query itself may be substituted for the base object, since it indirectly represents the interests of the user and in this way reveals information about him and his preferences.

To define the level of inverse similarity it is necessary to define the position of the base object among similar objects, the set of which is ordered in relation to that object, whose level of inverse similarity we are now defining.

When dealing with a search engine, we mentally invert the original search query. For each found query result we create a list of objects that are a good fit for it: objects similar to the base object, similarity to which defines the preference of the results (typically the base object is the user, in whose interest the search query was performed).

In other words, for each of the query results found by the original query, we perform a new search for objects similar to the result, which are also analogous (parallel) to the base object. We sort the found objects by their similarity to the object whose rank we need to define. Then we search for the original (base) object in the sorted list of analogous objects, found by the inverse search query.

In the simplest case, we sort the objects found in the inverse query in ascending order of their distance from the object, whose rank we need to define (the object used as the base of the inverse search query). However, the sorting criteria for inverse queries may be any other criteria, which are appropriate to the requirements of the given subject area.

To this end, it is not necessary to directly perform “inverse” search queries for each of the found objects that need to be ranked from the original (base) query. In a few applications all the necessary information may be calculated ahead of time and saved (permanently or in cache) for repeated use, which renders actual “inverse” search queries unnecessary in the process of ranking the results of the base search query.

The specific methods of calculating the values of similarity (or distance) between objects do not make up an essential part of this invention, and may be any that are appropriate to the subject area, in which this invention is used. The methods of ranking, described in this patent application, may be combined with any methods for calculating the value of similarity (or distance) between objects.

For the purpose of describing the patented method, the only significant variables are the value of distance or the values of similarity between a given object from the class of base objects and the ranked object that was the result of the original search query.

To be more specific in our exposition, we use the distance between objects, and not their values of similarity between each other. These two variables are interchangeable from the point of view of a specialist skilled in the art. All the formulas and algorithms, which use distances, may be easily converted into formulas and algorithms, which use values of similarity, and vice versa.

We call this distance “D”. For convenience, we assume that variable “D” has a range of [0, 1] or that the standard value of “D” lies within the interval [0, 1]. A specialist skilled in the art could easily adapt the patented methods to other assumptions concerning distance “D”.

The basic idea of the method of evaluating the level of inverse similarity lies in the fact that when this level is higher, the position of the base object among all the similar objects sorted by their similarity to the selected query result of the original search query is also higher. Conversely, the farther the base object is from the top of the list of similar objects sorted by their similarity to the given query result from the original search query, the lower the level of inverse similarity of the query result.

For example, in the application of a job search, the higher the level of inverse similarity of a vacancy, the closer the candidate, for whom we found the vacancy, to the top of the list of best candidates for the given vacancy sorted by their level of similarity to the requirements of the given vacancy.

We sort the entire set of objects, similar to the base object and similar to the given query result of the original search query, in increasing order of their distance from the query result. Next the object, which is most similar to the given query result, is found at the top of the sorted list. We calculate the position, which the base object occupies in this list. Let the number of its position in the sorted list be equal to a variable, which we will call “N”.

For example, in the application for a job search we sort all of the candidates who are applying to a ranked vacancy in descending order of their similarity to that vacancy (or in ascending order of the distance between an ideal candidate and the given applicant). Now the candidate who is the most similar to the given vacancy is first on the list. We calculate the position that the candidate, in whose interest the job search was carried out, occupies in the sorted list. We designate this position “N”. This means that only (N-1) applicants possess greater similarity values than the value of the given candidate.

For the purpose of more simply sorting the results of the search query it is sufficient to use the value of variable “N” directly as a rank.

This variable may be shown to the user and be of immediate concern to him, since it illustrates well his chances of getting the job, of successful dating, etc.

We understand the independent value of the given criterion and its display to the user and we are patenting the method of calculating the variable “N”, described above, the methods of approximating the variable “N” described below, and the system, which displays directly to the user the calculated value of the variable “N” and/or any indicator, which may be changed depending on change in the variable “N” (an indicator, which consists of any function of the variable “N”, its approximation, or its analogues).

In order for it to be possible to determine complex evaluations from many factors, the variable “N” must be calculated as a similarity value with a range of [0, 1] (its standard values lie in the interval [0, 1]).

Clearly, the level of inverse similarity “B” decreases as “N” increases, and is in fact a variable, which is inversely proportional to some (usually increasing) function of “N”:

$$B = \frac{1}{f ( N )}$$

For practical purposes, a function f(N) may be used, such as, for example, an exponential function:

B=N^{-a}

Or a more complicated function may be used, which includes a logarithmic function:

B=(1+log_{b} N)^{-a}

In these formulas, the exponent “a” and the logarithmic base “b” may be selected empirically and/or on the basis of mathematical models, which describe the decrease of interest in objects, found far from the top of the list. For example, the exponent “a” and the logarithmic base “b” may be selected by way of analyzing a large amount of experimental data (through the use of statistical methods).

In calculating the level of inverse similarity, it is possible not only to take into account the position “N” directly, but also a variable that correlates with it: the difference between the distance from the base object (D_{base}) and the first (leading) object in the sorted list of objects that are similar to the given result of the original query (D_{leader}):

B=g(D_{base}−D_{leader})

Here g is any function, preferably a function with a value of “1” when the difference of distances is zero. This function may be implemented using a mathematical model and/or accumulated statistics linking the difference of distances with position “N”.

If the distribution of distance “D” is inconsistent or not precisely known, then using the difference of distances yields a less accurate prediction than one derived from the position of “N”. However, using the difference of distances allows one to limit the real or fictitious “inverse” search queries to only those most similar to the object to define the only unknown variable D_{leader}.

Such a method of calculating variable “B” may be viewed as being based on an approximation of the variable “N” through the difference of distances.

In a few applications it is not always possible to construct a new or, conversely, to save in memory, the entire list of objects similar to a given query result. In these cases, it is difficult to precisely define the value of variable “N”.

Nevertheless, the patented method remains valid. If the exact value of “N” will be replaced by an approximation derived from existing data, or if it is calculated by a mixed method, which uses both an approximation and a search of the actual list, then for the approximation, in particular, histograms may be used, describing the distribution of values of similarity of objects in “inverse” search queries.

Generalizing further, we may say that variable “B” is the probability that a person pays attention to an object not found at the beginning of the list (or that such an object will be of interest to some process).

In that case, variable “B” may depend not only on “N”, but also on the absolute values of the variables D_{base} and D_{leader} (users like high percentages of similarity), and on the difference D_{base}−D_{leader} (users do not like objects, which are far away from the leader). Variable “B” may also depend on the general quantity of objects, found by the inverse query (we will call this quantity “M”), or on other parameters, such as the derivative of distance in the list.

A specific model describing this dependency does not make up a large part of this invention, which is based on utilizing the very existence of such a dependency. We call the dependency “p”:

B=p(N, D_{base}, D_{leader}, D_{base}−D_{leader}, M, . . . )

Different applications, which utilize this invention, may use different implementations of function “p”. The critical idea of this invention is the very proposition of using the level of inverse similarity to rank query results, predicting the probability that someone will pay attention to the base object, if it is not found at the very beginning of the list of the “inverse” query.

We defend as the essence of this invention the specific formulas and the general method of calculating variable “B” through a function adapted to a specific application from a complete set or subset of the parameters listed above, in accordance with the idea of the presence of a stronger interconnection between the position of the base object in the sorted list of inverse query results and the interest in the base object by the user who performed the original search (the results of which are ranked).

We also defend as the essence of this invention the usage of these universal methods for solving other ranking problems, including those not directly connected with search engines.

Selectivity of the Inverse Query

The second factor for ranking found objects in the results of the search query is the selectivity of the inverse query.

This factor is illustrated in the following example. Let us assume that a system for job search found vacancies, which are appropriate to a given applicant, and now needs to place them in descending order of preference. In the general case, a vacancy is more preferable if there are fewer appropriate candidates for it. As a rule, vacancies, for which there is a large quantity of appropriate candidates, are associated with less-skilled labor. They do not impose strong screening (restrictive) requirements on their applicants' qualifications, and for this reason, there is a rather large quantity of people who are appropriate for these vacancies.

As a rule, the presence of a very large quantity of applicants for a given vacancy means that even the best candidates for this vacancy are easily replaceable. Consequently, when an applicant is applying for the job, the employer will be inflexible in considering extenuating circumstances, and will also value hired employees less, since he may easily fire them and hire new ones.

For this reason, in the majority of cases the applicant will be interested in lowering the rank of indiscriminate (broadband) vacancies in the query results, and it is necessary to give him this option.

To describe the patented method, we define the similarity factor of ranking formally, and we give it a numerical value.

Let us call the factor of the selectivity of inverse query “S”. To calculate this factor, it is necessary to evaluate the volume and quality of the set of objects similar to the base object that are appropriate to the given ranked query result.

In the simplest case, we can consider the selectivity of inverse query “S” as inversely proportional to some increasing function of the quantity of found objects in the inverse query, taking only those found objects whose distance from the ranked object is lower than some threshold Dₗᵢₘᵢₜ. We call the quantity of these objects “L”. Then:

$$S = \frac{1}{f ( L )}$$

For practical purposes, for function f(L) we may use, for example, an exponential function:

S=L^{-a}

Or we may use a more complicated function, which includes a logarithmic function:

S=(1+log_{b} L)^{-a}

In these formulas, the exponent “a” and the logarithmic base “b” may be determined empirically and/or on the basis of mathematical models describing the decrease of interest in objects, which have a large quantity of good inverse similarities. For example, the exponent “a” and the logarithmic base “b” may be determined by means of analyzing a large volume of experimental data (through the use of statistical methods).

In general, the selectivity of inverse query may be described as some function “s” of the variable L described above, of the general quantity of objects found by the inverse query (M), and of other parameters:

S=s(L, M, . . . )

Different applications for this invention may use different implementations of the function “s”. The critical idea of this invention is the very proposition of using, to rank query results, the selectivity of the inverse query as a variable reflecting the power of a set of objects with high similarity.

Filtering a set of objects found through inverse query by a few limits on the value of their similarity to the ranked object (the result of the original search query) is necessary in order to limit the objects, by their value of selectivity of inverse query, to only those that are “sufficiently similar”.

For example, when evaluating the selectivity of vacancies it is necessary to evaluate the quantity of candidates with values of similarity to the vacancy who are hirable from the point of view of the employer, and not the general quantity of candidates who are appropriate by such formal criteria as location of residence, but possess lower, less hirable values of similarity to the professional requirements. The real competitors for being hired are only those people with high similarity to the professional requirements, and not all those found by the formal definition of a candidate.

The limit of sufficient similarity, which we defined as Dₗᵢₘᵢₜ, may be determined by the user. For example, in a system for job search the employer himself may define the limit when he creates the vacancy.

However it is unrealistic to assume that in all applications, users themselves will be able to accurately determine the limit of sufficient similarity.

In the simplest case, the limit of sufficient similarity for filtering a set of objects found by an inverse query may be defined as a constant limited by the maximum distance “D”.

However, better results may be achieved if this limit is determined by the distance from the found object D_{leader} plus some confidence interval “ε”:

Dₗᵢₘᵢₜ=D_{leader}+ε

Another way to define the limit of “sufficient similarity” is by using the Pareto principle. For example, we may select the variable D_{leader} in such a way that the sum of all similarity values (or quantity of objects) higher than the limit correlates with the sum of all objects (or quantity of objects) lower than the limit, in a proportion such as 20 to 80 (or in another proportion, determined empirically or through the use of statistical analysis).

To specify the limit of “sufficient similarity” we may also analyze the derivative of the similarity value (distance from the ranked object) in the sorted set of appropriate objects. If the derivative is greater than the defined variable, then all remaining objects are discarded.

The specific method of filtering the set of objects by defining the limit of “sufficient similarity” does not make up a large part of this invention, and may be replaced by or combined with any other method in a specific application.

This does not affect the general principle, the essence of which consists of using the values of sizes of the set of sufficiently similar objects for calculating the selectivity of inverse query, and then using the calculated selectivity for ranking objects found by the original search query.

This general principle, and not just the specific formulas or the method of filtering, we are defending as the essence of this invention.

In some applications it is not feasible to construct a new every time or, conversely, to save in memory the entire list of objects, similar to the given query result. In this case, the precise definition of the variable “L” or D_{leader} is difficult. However, the method remains valid, even if the exact variable “L” or D_{leader} will be replaced by its approximation, determined on the basis of existing data, or if it will be calculated by a mixed method, which uses an approximation, and a search of the actual list. For the approximation, in particular, histograms will be used describing the distribution of the values of similarity of objects in “inverse” search queries.

To this end, it is not necessary to directly perform “inverse” search queries for each of the found objects that need to be ranked from the original (base) query. In a few applications all the necessary information may be calculated ahead of time and saved (permanently or in cache) for repeated use, which renders actual “inverse” search queries unnecessary in the process of ranking the results of the base search query.

The factor of selectivity of inverse query may be used not only to rank objects in the query result, but also to automatically detect spam (search spam) and indiscriminate advertising, and for automatically revealing poorly created search queries.

For example, in a system for finding employment this factor may be used for detecting substandard vacancies, to which an overly large quantity of people are similar. These may be poorly defined vacancies, or they may be specifically designed to abuse the service, for example, for the purpose of mass distribution of an advertisement disguised as a vacancy (for example, for the purpose of attracting applicants to various multi-level marketing or Ponzi schemes).

Vacancies of this sort will have lower selectivity of inverse query, since the spammer or swindler wants to convey his advertisement to a wide range of people and deliberately creates a vacancy with weak criteria of selection. For this reason, these vacancies may be automatically detected by the low value of the variable “S” (with the following manual alteration, if it is necessary).

In the application for a dating website, oriented towards people searching for serious, long-term relationships, the factor of selectivity of inverse query may be used not only for detecting spammers and hidden advertisement, but also for automatically detecting people who lacks serious intentions.

Such people, as a rule, are interested in showing their profile to the maximum quantity of candidates for dating. Accordingly, they will not use strict limits in requirements when searching for potential dating candidates.

As a result, their queries will be characterized by a low value of the variable “S” and may be automatically detected on the basis of this variable and filtered out or lowered in the query results as a result of the ranking.

Calculation of Integral Value for Ranking a Set of Objects

In order to rank and distribute in the correct order either query results or an arbitrary set of objects, it is typically necessary to take into consideration not just one, but many factors, which are connected to the preferences and expectations of the user.

We will call the value of the sum, which considers all the factors available for automatic analysis, the integral value of attractiveness of the found object (its rank) and we designate this value “R”.

Two base factors, which influence this value, were already described above: the level of inverse similarity “B” and the selectivity of the inverse query “S”.

The integral value may also take into consideration the original (possibly not coinciding with one another) similarity values between the base object and the found object, and vice versa.

Besides these factors, the calculation of the integral value may also take into consideration supplementary factors specific to a certain subject area. For example, for an application for job search, when evaluating the vacancies from the point of view of the applicant, it may take into account the factor of the similarity of the vacancies to the tangible expectations of the applicant (which will be examined in detail below).

The calculation of the integral value may also use “external” factors, the means of calculating which are not associated with this invention, but which, in this case, may be considered along with other factors in the general evaluation, and for which priorities may be assigned by the general scheme, described below as part of this invention.

We designate the values calculated for individual factors, which are considered in the specific application Rᵢ. We designate the weights of these factors Wᵢ.

The weight of a factor is defined by the preferences of the user and/or the correlation between this factor and the real interest of the person in the objects found in the query results, if this correlation has been evaluated (for example, heuristically, or even by independent research about the connection of the given formal factor and the selection that real people make).

Next, the integral value of attractiveness of the found object (its similarity to the expectation and preferences of the user) may be calculated by some function, for example, the weighted average (arithmetic mean, geometric mean or some other average) of all the constituent factors. For example:

$$R = \frac{{\sum }_{i}^{all factors} {W}_{i} \cdot {R}_{i}}{{\sum }_{i}^{all factors} {W}_{i}}$$

The weight of each factor may consist of two components: the correlation coefficient (possibly smoothed by a Fisher Transform or some other transform) “Cᵢ” and the user preference “Uᵢ”:

Wᵢ=Cᵢ·Uᵢ

Individual factors may be complicatedly linked with each other, in which case, the simple value obtained by the weighted average with weights of the type Cᵢ·Uᵢ will not give the best results. In this case, to calculate the integral value “R” more complicated probabilistic filters or neural networks may be used, which take into account the mutual correlation between factors.

Use of a different formula or algorithm to calculate “R” neither negates nor alters the validity of the other claims of this patent application.

One of the key claims of this invention is the presentation to the user of the search engine interface, through which the user may select criteria, by which the system will subsequently rank query results and assign them weights. When selecting criteria, the user distributes them in descending (or ascending) order of importance, or by other methods assigns weights Uᵢ to each criterion.

In this way, the user may specify not only the search query, but also clearly communicate to the search engine his own priorities and preference for sorting the found objects.

The user may be given the opportunity to explicitly or implicitly (by distributing the factors in descending or ascending order of their importance, by explicitly specifying the weights of factors or by designating the importance of factors by another method) assign his own subjective preferences, that is, to specify the weights of factors Uᵢ for each of the characteristics considered by the integral value.

The implicit assignment of the weight of a factor may be expressed as a function of its position “i” in the ordered list of factors:

Uᵢ=f(i)

For practical purposes we may use, for example, a power function:

Uᵢ=i^{-a}

Or an exponential function:

Uᵢ=c⁻ⁱ

In these formulas the exponent “a” or the base “c” may be determined empirically and/or by mathematical models, which describe the decrease in importance of factors, which the user placed toward the bottom of the list. For example, the exponent “a” or the base “c” may be determined by analyzing a large volume of experimental data (through statistical methods).

Specific graphical interfaces for ranking factors by implicit assignment of their weights, along with specific methods of calculating weights for use in these interfaces, are examined in a separate patent application, since they do not make up a large part of this invention.

The methods of ranking described in this patent application retain their validity for any method of calculating weights for individual factors, so long as this method is appropriate for the specific subject area in which the patented method is used.

Specialization for Specific Applications (Embodiments)

Although the level of inverse similarity and the selectivity of the inverse query themselves are good factors for the ordering search query results, in practical applications we can take into account additional factors, which make the ranking even closer to the estimates made by the human user.

Application for Job Search

In this section, supplementary (specific) factors that may be used in applications for job search are examined.

In the following text, the process is described as an applicant sees it. However, each of his steps could be naturally and symmetrically converted by a specialist skilled in the art to the employer's perspective, up to the alteration of “vacancies” and “users” in texts (as search objects) and the replacement of some terms in the text with others. Neither the system nor the method is changed, only the terminology, which does not make up a large part of or the essence of this invention.

The basic measureable factors of ordering, which the actual method may automatically predict, and which influence the preference of a vacancy for a user, are as follows:
Similarity of the vacancy to the tangible expectations of the user (similarity to expectations regarding salary, benefits package, etc.);
Probability of being hired for the given job;
Job security;
Rare combination of characteristics in the vacancy;
Probability of encountering difficulties in work due to insufficient suitability of the candidate to the requirements of the employer in skill level, practical experience, or psychological traits.

Although the calculated factors do not make up the entire formalization, for each of them it is possible to determine a prediction (value), using formal criteria that correlate with it.

The application for job search described below, which is one of the applications of this invention, calculates the order of factors described in this patent application, for example, it calculates the level of inverse similarity that is necessary to know the value of similarity (or distance) between the applicant and the vacancy.

To calculate the values of similarity (or distance) between vacancies and applicants we may use, for example, the value of the applicant in individual characteristics, which make up the requirements of the given vacancy.

The value of an applicant in an individual characteristic may be requested of him directly, taken from his diploma or certification, and/or calculated from the results of online or offline testing.

We may also compare the individual answers by the applicant to questions on tests, which are similar to the characteristics making up the vacancy, with the answers of ideal candidates, for example, as described in the patent application, docket number P2123, which bears application Ser. No. 11/853,771, filed Sep. 11, 2007, and provisional patent application No. 60/843,823, filed Sep. 11, 2006.

Further, the weighted average (arithmetic mean, quadratic mean, or some other average) value of individual characteristics required by the vacancy may be used for the purpose of determining the value of similarity between a given applicant and the vacancy as a whole.

This value may also take into consideration other factors, including some of the factors described in this patent application, which, for example, may be added to the value of similarity through the method of calculating integral values described above.

The methods of ranking and algorithms described in this patent application may be used with any other methods of calculating the values of individual characteristics, which make up the vacancy, and also with other methods of calculating the general value of similarity (or distance) between the vacancy and the applicant (as on the basis of the values of individual characteristics, and by other methods).

Similarity of the vacancy to the tangible expectations of the applicant The similarity of the vacancy to the tangible expectations of the applicant is a very simple, but very important factor for evaluating and ranking found vacancies.

The applicant may assign boundary conditions for the salary and outline requirements for the benefits packages that are acceptable to him. Simple filtering by the acceptable limits on salary or by the presence of the defined options in the benefits package (health care plan, vision plan, dental plan, pension plan, etc.) is provided by practically any developed system for job search.

In this invention we go further, and beyond checking by the boundary conditions formally, we also define the numerical value (we introduce the measure) of similarity (or dissimilarity) between the expectations of the candidate and the offer made by the employer.

We describe a few methods of evaluating the salary proposed by the employer.

In the simplest case it is necessary to divide the salary proposed by the employer (we call this value S_{employer}) by the salary expected by the applicant (we call this value S_{candidate}) and in this way we obtain a numerical evaluation of the similarity or dissimilarity of the salary to his expectations (we call this value “P”):

P=S_{employer}/S_{candidate}

To strengthen the large superiority or large dissimilarity to the salary requirements, the relationship of salaries may be strengthened by a supplementary function, for example, an exponential function:

P=(S_{employer}/S_{candidate})^{a}

In this formula the exponent “a” may be determined empirically and/or on the basis of a mathematical model, which describes the growth of attractiveness of salary when exceeding the lower threshold set by the user (acceptable standard of living). For example, the exponent “a” may be determined by means of analyzing a large volume of experimental data (through statistical methods).

Another function may be used, based on the relationship or on the difference between the salary proposed by the employer and the salary requested by the applicant. The essence of this invention is that the relationship of these variables is important for the quantitative (numerical) evaluation of similarity of the vacancy to the expectations of salary. The specific coefficients and specific form of the function for calculating the variable “P” may differ depending on the subject area however the general principle of using the relationship of the indicated variables for calculating the value of “P” does not change, and is the essence of this invention.

The obtained value of similarity to expectations of salary (“P”) may be bounded above by some constant Pₗᵢₘᵢₜ that is particularly important when subsequently including it in the calculation of the general value of the vacancy, when it is necessary to avoid suppressing a very high salary's negative influence on different factors, which are taken into consideration in the general evaluation of the vacancy:

P_{new}=min(P, Pₗᵢₘᵢₜ)

If the vacancy does not assign a salary, similarity to the requested salary may be artificially set to one. We optimistically assume that the employer and the employee will come to an agreement.

In the same way, any other material expectations may be evaluated, which can be quantitatively expressed.

Material expectations, represented by the options “yes/no” (for example, the presence of a vision or dental plan in medical insurance) may be evaluated as 0 in the absence of the option, and as 1 when the expectation matches the offer.

The integral value of similarity of a vacancy to tangible expectations of the applicant P_{integral} may be calculated as some function, for example, the weighted average (arithmetic mean, quadratic mean, or some other average) of the values that are similar to individual factors Pᵢ, just like the similarity to expectations of salary or medical insurance. For example:

$${P}_{integral} = \frac{{\sum }_{i}^{all factors} {w}_{i} \cdot {P}_{i}}{{\sum }_{i}^{all factors} {w}_{i}}$$

The applicant may be given the possibility to explicitly or implicitly (by placing the factors in descending or ascending order of their importance, or by indicating their importance through another method) assign his own subjective preferences, that is, he may specify the weights on the constituent factors wᵢ.

When assigned implicitly, the weight of a factor may be expressed as a function of its position “i” in the ordered list of factors:

wᵢ=f(i)

For practical purposes we may use, for example, a power function:

wᵢ=i^{-a}

Or an exponential function:

wᵢ=C⁻ⁱ

In these formulas the exponent “a” or the base “c” may be determined empirically and/or on the basis of a mathematical model, which describes the decrease in importance of factors that the user places towards the bottom of the list. For example, the exponent “a” or the base “c” may be determined by analyzing a large volume of experimental data (through statistical methods).

Specific graphical interfaces for ranking factors when implicitly assigning their weights, along with specific methods of calculating weights when using these interfaces, are examined in a separate patent application, since they do not make up an essential part of this invention.

The methods of ranking described in this patent application remain valid when any method of calculating weights for individual factors is used, so long as this method is appropriate for the specific subject area, in which the patented method is used.

We are patenting the following very important and precise method of evaluating weights of benefits packages for the purpose of calculating the value of similarity of a vacancy to the tangible expectations of the candidate.

The user evaluates each of the benefits packages of interest to him in addition to his salary. That is, he evaluates each option of interest to him in terms of money, communicating to the system how much (from his point of view) the given option costs. Then the weights wᵢ for each option of a benefits package are set equal to these monetary values given by the user. If the option is not of interest to the user, and he did not indicate a value for it, then the corresponding weight is set equal to zero. The weight wᵢ for the salary itself coincides with the expectations of the user S_{candidate}. Next, the value of similarity of the vacancy to the tangible expectations of the candidate is calculated as described above, taking into consideration these weights.

Probability of Being Hired for Given Employment

In accordance with the main idea of this invention we propose that the probability of being hired for given employment depends directly on the position of the given applicant on the employer's list of the most appropriate candidates for the given vacancy.

That is, the probability of being hired for given employment is directly proportional to the level of inverse similarity described above.

For the patented method it is not important exactly how the similarity (suitability) of a candidate to the requirements of a vacancy is calculated (this value should not be confused with the value of similarity of the given vacancy to the requirements of the candidate, since they are calculated in the interest of different people, and these people may have different interests and therefore different criteria for evaluating similarity).

Job Security

The factor of job security, in the simplest evaluation, is a variable that is inverse to the probability of being hired for given employment: the higher the probability of being hired for the candidate, the lower the probability that he will lose his/her job.

As a rule, the higher the position of the given candidate on the list sorted by the value of the applicant for the given vacancy from the point of view of the employer, the less worthy candidates remain who could replace the given candidate in the given job while still bringing to the employer the same benefit.

For example, the first candidate on the list (provided that we are able to correctly calculate the value from the point of view of the employer) may not be replaced by any other candidate without a loss in quality or the amount of useful work, since among the remaining candidates there is no one who is a better fit for the given vacancy. This means (in theory) the benefit from any other candidate will be, even if only by a small amount, less. Conversely, the hundredth candidate on the list may be easily replaced by 99 other candidates, whose values are higher than his.

If the value of the vacancy already takes into account the probability of being hired for given employment, then it is not necessary to recalculate it directly, since the given employment's job security is expressed through it.

There is one factor that may be used to evaluate the job security (probability of losing the job) (we designate this variable “F”), this factor is the selectivity of inverse query (variable “S”), which was described above.

We propose that it is in the interest of the employee to receive such employment, for which he is difficult to replace, because the difficulty of searching for an adequate replacement for the employer reduces the employee's risk of being fired.

Since the variable “S” evaluates the measure of a set of appropriate candidates and increases as the quantity of appropriate candidates decreases, the greater this variable, the lower the risk to his job security (variable “F”):

F=1−S

Furthermore, when the search engine possesses sufficient statistics, factors of analysis of the real market may be used to evaluate job security, such as demand in the market for the given vacancy in excess of the supply for it.

Rare Combination of Characteristics

There is a possible paradoxical situation, when a vacancy does not end up on the list of best vacancies for its own best candidates, that is, the level of inverse similarity for this vacancy possessed by the candidates is not very high, but it still is of substantial interest for these potential applicants.

As a matter of fact, sometimes a company seeks a specialist with a very rare combination of characteristics; so rare, that very few people are similar to it.

We will examine a complicated example. Let us assume that we need a person, who is very well experienced in trading on the New York stock exchange, and is at the same time and excellent programmer. We propose that the combination of skills in both areas is found in only a few people from the millions of users in the system. They far surpass the remaining candidates for this vacancy.

However, each one's skill in programming may be slightly lower than the level of professional programmers, or conversely, his skill in trading on the exchange falls short of the level of professional brokers. For this reason, each candidate's list of best vacancies is full of simple vacancies for either brokers or programmers.

Yet if for the candidates in the first and second position for the vacancy with a rare combination of characteristics in the ranking only by level of inverse similarity this vacancy has high chances of appearing on the list of the very best, then for the remaining strong candidates it may not appear in the ten best vacancies, since many simple vacancies can be found for programmers or brokers, in the lists of which these candidates occupy the first places.

However, due to the uniqueness of the job, this vacancy may be of great interest to all of its applicants. This includes those, for whom it would not appear in the list of best vacancies calculated only by the level of inverse similarity, since the potential employer is highly motivated to offer such rare specialists excellent conditions and with such a limited selection of candidates for the new employer, employees are hardly at risk of losing their jobs.

We also take into account that the first 2-3 people in the list of the most suitable candidates for this job position (who have a higher level of inverse similarity), can refuse employer's proposition. Then, the chances of the other candidates are even higher, although until a formal waiver from the best candidates the level of inverse similarity for the vacancy (for the all of its remaining candidates) will not rise.

The method described in this patent application may automatically detect these sorts of vacancies. To this end, it is sufficient to analyze the selectivity of inverse query (the variable “S”, described above), which will be very high for them.

These vacancies are distinguished by the high rate of change of the values, or in other words, by the rapid decline of the value in the vacancy's list of best candidates. Practically all appropriate candidates for these vacancies are found at the top of the list the employer sees. Even shortly after the top of the list there is a rapid decline in the level of similarity.

For this reason they can be easily detected by analyzing the selectivity of inverse query, since they receive a very high value for this factor.

Unfortunately, the employer may obtain the examined situation unintentionally, if he creates the vacancy poorly. He may search for a rare combination of characteristics not because he really needs such a rare specialist, but because he unnecessarily inflated his requirements for a future employee.

For this reason, a high value of selectivity of inverse query may display a warning to the employer. Having received such a warning, the employer may reconsider and carefully review the contents of his vacancy. The warning may be displayed, for example, prior to the posting of the vacancy, or when showing the query results.

Probability of Encountering Difficulties at Work

For a job search engine that is based on the analysis of skills, practical experience and psychological characteristics of the applicant, the probability of encountering difficulties at work may be evaluated by analyzing the level of similarity of the candidate to the requirements of the given vacancy.

The probability of encountering difficulties at work, which we designate “T”, is higher, the stronger the dissimilarity of the candidate to the necessary requirements of skills, practical experience, and psychological characteristics that the given vacancy has imposed.

However, in practice, it is not to be expected that the employer knows precisely the necessary level of similarity for each of the characteristics that make up his vacancy.

For this reason, in this patent application we are proposing that for the probability of encountering difficulties at work we use the distance between the real applicant, and some virtual candidate for the given vacancy, whose skill and experience level in the individual characteristics either meets the minimal necessary level established by the employer, or is completely perfect (in those characteristics, for which the employer did not indicate the minimal acceptable level of similarity).

We designate the variable of the distance for an individual characteristic “i” between the virtual candidate and the real candidate Dᵢ. The variable Dᵢ may be negative if the level of similarity to the individual characteristic of the applicant exceeds the necessary minimum established by the employer.

The probability of encountering difficulties at work, evaluated for the individual characteristics, which we designate Tᵢ, is some increasing function of the variable Dᵢ:

Tᵢ=f(Dᵢ)

For practical purposes, this probability may be evaluated by, for example, an exponential function:

$${T}_{i} = \{ \begin{matrix}{D}_{minimal}^{a} , & {D}_{minimal} > 0 \\ 0 , & {D}_{minimal} \leq 0\end{matrix}$$

In this formula, the exponent “a” may be determined empirically and/or on the basis of a mathematical model that describes the probability of encountering difficulties at work depending on the lack of skill, knowledge, experience or of poor similarity to the requirements for personal characteristics. For example, the exponent “a” may be determined by analyzing a large volume of experimental data (through statistical methods).

The general value of the probability of encountering difficulties at work may be calculated as a weighted average (arithmetic mean, geometric mean or another average) of all variables Tᵢ, by using the weights established by the employer for the individual characteristics for the vacancy, which we designate wᵢ. For example:

$$T = \frac{{\sum }_{i}^{all requirements} {T}_{i} \cdot {w}_{i}}{{\sum }_{i}^{all requirements} {w}_{i}}$$

The probability of encountering difficulties at work may also be calculated not for each vacancy as a whole, but for individual characteristics that make up the vacancy, in order to determine the most important of them. This includes the weights of these characteristics in the calculation.

This factor, calculated for individual characteristics, may also be used as a clue for the user about which areas of skill, professional experience or personal characteristics he should develop in particular to work successfully in the given vacancy.

Applications for Dating Services

In this section supplemental factors are examined, which may be used in applications for dating websites.

The key factors for ordering, which this method may predict automatically, and which influence the preference of people for one another, such as:
Probability of successful dating;
Probability of shifting attention to another candidate;
Request for a rare combination of characteristics;
Probability of encountering difficulties in relationships;
Presence of mutual interests.

Although the listed factors do not make up the entire formalization, for each of them it is possible to make a prediction (value), using formal criteria that correlate with them.

In the application for dating websites described below, which is one of the applications of this invention, to calculate the order of factors described in this patent application, for example, to calculate the level of inverse similarity, it is necessary to know the value of similarity (or the distance) between two real people or between a real person and an ideal candidate, whom another user seeks.

For calculating these original values of similarity (or distance) between two real people or between a real person and an ideal candidate, whom a given user seeks, we may use, for example, the values of similarity or distance for the individual characteristics that make up the requirements of people for one another.

The value of similarity of the found candidate in an individual characteristic coincides with his value in this characteristic if when searching it implies comparison with some ideal candidate who is ideally similar to all the requirements that another person assigned (as his own search criteria).

If the search implies comparison of people with one another, then the distance of an individual characteristic may be calculated as the difference between the values of two people in this characteristic. Also, if necessary, the value of similarity is calculated by subtracting the distance from one.

Furthermore, we may also use the comparison of people's answers to individual questions from different categories, for example, as described in the patent application, docket number P2123, which bears application Ser. No. 11/853,771, filed Sep. 11, 2007, and provisional patent application No. 60/843,823, filed Sep. 11, 2006.

Also, the weighted average (arithmetic mean, quadratic mean or another average) of values of similarity in individual characteristics (or the distance between candidates in individual characteristics) may be used as the value of similarity (or distance) between a pair of people or between a real person and an ideal candidate, for whom a given person searches.

The value of similarity (or distance) between people may also take into consideration other factors, including some of the values described in this patent application, which, for example, may be added to the value of similarity through the method of calculating integral values described above.

The methods of ranking and algorithms described in this patent application may be used with any other methods of calculating the distance (or similarity values) in individual characteristics, and also with other methods of calculating the general values of similarity (or distance) between people (such as on the basis of distance in individual characteristics, and otherwise).

Probability of Successful Dating

In accordance with the main idea of this invention, we propose that the probability of successful dating directly depends on the position of a given person seeking a dating partner on the list of most appropriate candidates for the potential partner.

That is, the probability of dating is directly proportional to the level of inverse similarity described above.

In other words, the very best chances of successful dating are possessed by those people who are in the first positions on the list of potential candidates, sorted by the value of their similarity to the requirements of a potential partner. These chances quickly decrease as the position that a given person occupies in the list of candidates of a potential partner increases.

The exact method of measurement of similarity between pair of people is not important to this invention. The values of similarity of people to each other's requirements are calculated on each one's behalf and these values may be different from each other, since the values of similarity of people to individual characteristics typically do not coincide with one another.

In addition, people typically possess interests and preferences that do not coincide with one another, and for this reason they indicate different requirements than the opposite side and assign different priorities to these requirements, and accordingly receive values of similarity that are not equal to each other.

Probability of Shifting Attention to Another Candidate

The factor of the probability of shifting attention to another candidate, in the simplest evaluation, is a variable that is inverse to the probability of successful dating: the higher the probability of successful dating, the lower the probability of shifting attention to another person.

As a rule, the higher the position of a given person in the list of candidates for dating of a potential partner (sorted by his/her criteria of evaluating similarity), the lower the amount of more attractive candidates for this partner that could compete with the given person without causing a feeling of losing a good chance (in the case of shifting attention to another of them).

For example, it is difficult to find a replacement for the very first, that is, the very best candidate on the list (provided that we are able to accurately calculate the values of similarity of people to the expectations and preferences of one another). Conversely, the hundredth candidate on the list may easily be replaced by 99 other candidates whose values of similarity are higher than his.

If the value of the candidate already takes into consideration the probability of successful dating, then it is not necessary to recalculate it, since the probability of shifting attention to another candidate is expressed directly through it.

There is one factor that may be used to evaluate the probability of shifting attention to another candidate (we designate this variable “F”), this factor is the selectivity of inverse query (variable “S”), which was described above.

We propose that it is in the interest of the person to find such a partner who will not look at him as one out of many who may easily be replaced by someone else, because difficulty in finding an adequate replacement reduces the risk of ending the relationship. When there is a large quantity of roughly equivalent candidates, the risk increases of shifting attention to another potential partner at the slightest conflict of interest.

Since the variable “S” evaluates the measures of a set of appropriate candidates, and increases as the quantity of candidates decreases, the higher this value, the lower the probability of shifting attention to another candidate (candidate “F”).

F=1−S

Request for a Rare Combination of Characteristics

A paradoxical situation is possible, in which another person does not make it onto the list of best candidates for dating a given person, that is, his level of inverse similarity is not very high, but nevertheless he is of significant interest to the given person.

The fact is that another person may be attracted by a rare combination of characteristics, by which he searches for partners. If the person searches for people with such a rare combination of characteristics that only very few people are similar to him, then each of the found candidates will be of great interest to him. Furthermore, in the case of successful dating he will highly value a relationship with the found person, since he knows that only very few people satisfy his requirements. In addition, a person might find comfort in the fact that he is, if not the only, then one of very few similar candidates for dating his partner.

For this reason another person who found the given person by a rare combination of characteristics may be interested in him even if the case is that the given person does not occupy the very first position on the list of potential candidates for dating. It is important to consider that “competitors”, occupying the first position on the list of best candidates for the potential partner may answer him with rejection.

The method described in this patent application may automatically detect these situations. To this end, it is sufficient to analyze the selectivity of inverse query (variable “S”, described above). This variable will be very high for those candidates for dating who seek for themselves a person with a rare combination of characteristics.

The query results of these people are distinguished by a high rate of change in their values, or in other words, by a very rapid decline in the value on their own list of best candidates. In fact, all good candidates for them are found at the top of the list. A sharp decline in the value of similarity begins shortly after the top.

For this reason these candidates for dating will be easily detected by analyzing the selectivity of inverse query, and in this factor they receive a very high value.

Unfortunately, the user may obtain the examined situation accidentally if he poorly creates his search query. He may search for a rare combination of characteristics not because he actually needs such a person, but because he is unnecessarily restrictive in his requirements for a potential partner, or because of a misunderstanding of the interface of the search engine.

In this case a high value of selectivity of inverse query may call up a warning to the user. Having received such a warning, he may reconsider and carefully review the characteristics and limits in his query. The warning may be displayed, for example, before posting the profile, or when showing the search results.

Probability of Encountering Difficulties in Relationships

For dating websites, which are based on searching by personal characteristics of people (including psychological characteristics) the probability of encountering difficulties in relationships may be predicted on the basis of the values of similarity of people to the requirements that they present to one another, for example, those in their own search queries and/or otherwise formulated for potential candidates for dating.

When the probability of encountering difficulties in relationships, which we designate “T”, is higher, then the dissimilarity of the candidate to the necessary requirements in psychological and other characteristics that another person presents to him when seeking a candidate for dating, is greater.

However, in practice, it is not to be expected that a person knows precisely and is always able to indicate the precise limits for each of his personal (or other) characteristics, by which he searches for candidates for dating.

For this reason, in the patented invention we propose using, for the probability of encountering difficulties in relationships, the distance between a real person and a virtual candidate for dating, whose similarity to the query requirements in individual characteristics is either at the minimum necessary level (taken from the criteria of the query), or is completely perfect (in those characteristics, for which the user did not indicate a minimal acceptable level of similarity).

We designate the variable of the distance in an individual characteristic “i” between a virtual candidate and a real candidate Dᵢ. The variable Dᵢ may be negative, if the level of similarity in the individual characteristics of the given person exceeds the necessary minimum established by the other party.

The probability of encountering difficulties in relationships evaluated for an individual characteristic, which we designate Tᵢ, is some increasing function of the variable Dᵢ:

Tᵢ=f(Dᵢ)

For practical purposes, this probability may be evaluated by, for example, an exponential function:

$${T}_{i} = \{ \begin{matrix}{D}_{minimal}^{a} , & {D}_{minimal} > 0 \\ 0 , & {D}_{minimal} \leq 0\end{matrix}$$

In this formula the exponent “a” may be determined empirically and/or on the basis of a mathematical model describing the probability of encountering difficulties in relationships depending on the level of dissimilarity to the characteristics, by which people search for one another. For example, the exponent “a” may be determined by analyzing a large volume of experimental data (through statistical methods).

The general value of probability of encountering difficulties in relationships may be calculated as a weighted average (arithmetic mean, geometric mean or another average) of all variables Tᵢ by using weights established by the user for individual characteristics in his search query, which we designate wᵢ. For example:

$$T = \frac{{\sum }_{i}^{all requirements} {T}_{i} \cdot {w}_{i}}{{\sum }_{i}^{all requirements} {w}_{i}}$$

This variable is asymmetrical. From the point of view of the user who performs the search, we designate the probability of encountering difficulties in relationships Tᵤₛₑᵣ. From the point of view of the potential candidate for dating, we designate this probability T_{candidate}. The variables Tᵤₛₑᵣ and T_{candidate} may not coincide, since the user who performs the search and the potential candidate for dating found by him may present different requirements to one another and may have different levels of similarity to these requirements.

Taking this into consideration, the value of the general probability of encountering difficulties in relationships T_{common} may be calculated as the maximum of these two variables:

T_{common}=max(Tᵤₛₑᵣ, T_{candidate})

The probability of encountering difficulties in relationships may also be calculated not by all the requirements of people as a whole, but by the individual characteristics that make up their requirements for one another, to determine the most important of them. This includes the weights of these characteristics in the calculation.

This factor, calculated for individual characteristics, may also be used as a clue for the user about the areas in which dissimilarity to the precise characteristic may result in difficulties in relationships.

To evaluate the probability of encountering difficulties in relationships we may also analyze not only those characteristics, which the user specified in a clear way as his requirements for a potential candidate for dating, but also some predetermined set of personal (psychological) or other characteristics, selected by the developers of the dating website.

Presence of Common Interests

The most important factor in dating is the presence of common interests. In this patent application we describe and defend the new method of quantitatively evaluating the similarity of users by their interests.

The presence of common interests may be calculated before ranking, during the calculation of preliminary distances or values of similarity between people, even though it is part of ranking the query results.

The simplest system that evaluates the presence of common interests may simply record whether two users indeed possess a common interest. However, such an approach is ineffective, since people are incline to specify amongst their interests on social networks and dating websites such general categories, as “family”, “career”, “relaxation” etc. As a result, almost all users of the site may intersect one another in at least one common interest.

A more complicated system may take into account the quantity of common interests. However this approach is also ineffective, since people who intersect one another in a large quantity of trivial interests (“family”, “career”, “relaxation”) will be considered more similar than people who intersect one another, for example, in an interest such as astronomy or ancient history. Nevertheless it is obvious that in the second case the real similarity in interests is much greater.

For this reason, the method that is described in this patent application takes into consideration not only the quantity, but also the quality of common interests. In particular, we suggest giving greater weight, through some function, to those interests that are shared by a lower quantity of people.

We designate the value of similarity by interests “I”. To define this variable we use a few steps:

Step 1. We sort all the found common interests of the users by ascending order of the number of people who share it. Now the rarest common interest is in the first place on the list, and the least rare common interest is in the last place on the list. We designate the quantity of people who share some interest in the list Zᵢ.

Step 2. In accordance with the idea described above, the weight of a common interest is a variable determined by some function that decreases as the quantity of people who share it increases. We designate the weights of general interests Qᵢ, then:

Qᵢ=f(Zᵢ)

It is desirable to select a function f (Zᵢ) in such a way that it takes a value in the interval [0, 1]. For practical purposes we may use, for example, a function with a logarithm of the quantity of people who share a given common interest:

Qᵢ=(1+log_{b} Zᵢ)^{-a}

In this formula the exponent “a” and the base of the logarithm “b” may be determined empirically and/or on the basis of a mathematical model describing the decrease in the value of common interest during an increase of the quantity of people who share it. For example, the exponent “a” and the base of the logarithm “b” may be determined by analyzing a large volume of experimental data (through statistical methods).

Step 3. We calculate the level of similarity by interests as a sum of the series:

$$I = {\sum }_{i}^{all interests} {Q}_{i}$$

In this approach the presence of nontrivial common interests possesses much greater significance than the quantity of common interests.

However, in practice the variable “I” may possess a value greater than one (if the value Qᵢ falls in the interval [0, 1]). Such behavior is bothersome when calculating the integral value. In addition, a very large quantity of trivial interests may have the same effect that the presence of one serious common interest has.

This problem may be solved, for example, by changing the formula in step 3 to the sum of the convergent series:

$$I = ( c - 1 ) \cdot {\sum }_{i} {c}^{- i} \cdot {Q}_{i}$$

In this formula the optional coefficient (c−1) serves to normalize the value of the variable “I” to one, and the value of “c” may be determined empirically and/or on the basis of a mathematical model describing the decrease in the value of the presence of individual common interests during the increase in their quantity. For example, the value of “c” may be determined by analyzing a large volume of experimental data (through statistical methods).

Another convergent series may be used that is not necessarily based on an exponential function.

The sorting of interests in step 1 is not necessary if step 3 does not use a formula with a convergent series or one similar to it.

Application for Social Networks

The application for social networks is very similar to the application for dating websites. It may use all the factors that were described above in the section “Application for dating websites”. Furthermore, they may also use those factors that were described in the section “Application for job search” (since a social network may be used for, among other uses, searching for specialists and for recruitment).

1. The system for searching objects based on the multi-attributive (multifactorial) search criteria and method for ranking search results or arbitrary sets of objects according to their attractiveness to the user or according to their attractiveness described formally, which numerically evaluates the attractiveness of search results using the inverse query matching factors and/or assessment of the likelihood of attention by another user and/or another techniques described formally in specification.

2. The system for searching objects based on the multi-attributive (multifactorial) search criteria designed to search for people based on their assessments of knowledge, skills, experience, personality traits and personal preferences, which allows the user to control the priority of individual search criteria and to sort search results according to their preferences, and allowing the use of the factors that predict the likelihood of a successful contact and reciprocity taking into account the interests of the parties involved in the search.

3. The system for searching objects based on the multi-attributive (multifactorial) search criteria, which displays to the user his/her position in the search results of another person or the another party in a process that involves search and/or the likelihood of successful interaction, evaluation of coincidence of their interests (taking into account nonequivalence of coincidence for different interests) and a number of other calculated factors, which described formally in the specification of the present invention.
